(19) United States
(12) Patent Application Publication
(10) Pub. No.: US 2026/0169752 A1
(43) Pub. Date: Jun. 18, 2026

(54) PROCESSORS, METHODS, AND SYSTEMS TO PERFORM IMMEDIATE FOLDING FOR LOGICAL REGISTERS HAVING DIFFERENT WIDTHS

(71) Applicants: Henry WONG, Hillsboro, OR (US); Rohan SHARMA, Hillsboro, OR (US)

(72) Inventors: Henry WONG, Hillsboro, OR (US); Rohan SHARMA, Hillsboro, OR (US)

(21) Appl. No.: 18/983,231

(22) Filed: Dec. 16, 2024

(51) Int. Cl. G06F 9/38; G06F 9/30

(52) U.S. Cl. CPC G06F 9/384; G06F 9/30098; G06F 9/30145

(57) ABSTRACT

A decode unit to decode a first instruction, a second instruction after the first instruction, and a third instruction after the second instruction. The first instruction specifies a source register, a first immediate, and a destination register. The second instruction specifies the destination register of the first instruction as a source register, a second immediate, and a destination register. The third instruction specifies the destination register of the second instruction as a source register. Circuitry, when an operand size of the second instruction is wider than an operand size of the first instruction, generates a second value from a first value obtained from a physical register mapped to the destination register of the second instruction, including truncating bits of the first value. The circuitry generates a value of the destination register of the second instruction, including combining the second value with an accumulated immediate incorporating the first and second immediates.

### BACKGROUND

### Technical Field

Embodiments described herein generally relate to processors. In particular, embodiments described herein generally relate to immediate folding in processors.

### Background Information

Many processors have an instruction set that includes instructions to add or subtract an immediate from a register. For example, the x86 instruction set architecture of certain processors of Intel® Corporation, of Santa Clara, California, includes an instruction “ADD EAX, imm32” that when executed causes the processor to add a 32-bit immediate (imm32) to the 32-bit general-purpose register EAX. The x86 instruction set architecture also includes an instruction “SUB EAX, imm32” that when executed causes the processor to subtract a 32-bit immediate (imm32) from EAX. In some cases, a program or code may include multiple (e.g., a chain) of such instructions that add or subtract their respective immediates from the same register.

### BRIEF DESCRIPTION OF THE DRAWINGS

Various examples in accordance with the present disclosure will be described with reference to the drawings, in which:

FIG. 1 illustrates a specific example of code including instructions to accumulate or combine their immediates with a register and contrasts an approach to perform single-size immediate folding on the instructions with an embodiment of an approach to perform mixed-size immediate folding on the instructions.

FIG. 2 is a block flow diagram of an embodiment of a method of performing immediate folding for logical registers having different widths.

FIG. 3 is a block diagram illustrating a logical register identifier mapped to a first embodiment of an extended register renaming representation of the logical register.

FIG. 4 is a block diagram illustrating a logical register identifier mapped to a second embodiment of an extended register renaming representation of the logical register.

FIG. 5 is a block diagram of an embodiment of a processor to generate a value of a logical register based on an extended register renaming representation of the logical register.

FIG. 6 illustrates an example computing system.

FIG. 7 illustrates a block diagram of an example processor and/or System on a Chip (SoC) that may have one or more cores and an integrated memory controller.

FIG. 8(A) is a block diagram illustrating both an example in-order pipeline and an example register renaming, out-of-order issue/execution pipeline according to examples.

FIG. 8(B) is a block diagram illustrating both an example in-order architecture core and an example register renaming, out-of-order issue/execution architecture core to be included in a processor according to examples.

FIG. 9 illustrates examples of execution unit(s) circuitry.

FIG. 10 is a block diagram of a register architecture according to some examples.

FIG. 11 illustrates examples of an instruction format.

FIG. 12 illustrates examples of an addressing information field.

FIG. 13 illustrates examples of a first prefix.

FIGS. 14(A)-(D) illustrate examples of how the R, X, and B fields of the first prefix in FIG. 13 are used.

FIGS. 15(A)-(B) illustrate examples of a second prefix.

FIG. 16 illustrates examples of a third prefix.

FIG. 17 is a block diagram illustrating the use of a software instruction converter to convert binary instructions in a source instruction set architecture to binary instructions in a target instruction set architecture according to examples.

### DETAILED DESCRIPTION OF EMBODIMENTS

Disclosed herein are methods, processors or other apparatus, computer systems or other systems, and optionally non-transitory computer-readable storage media to perform immediate folding on logical registers having different widths. In the following description, numerous specific details are set forth (e.g., specific sequences of operations, specific instructions, specific representations of logical registers, specific processor configurations, specific microarchitectural details, etc.). However, embodiments may be practiced without these specific details. In other instances, well-known circuits, structures, and techniques have not been shown in detail to avoid obscuring the understanding of the description.

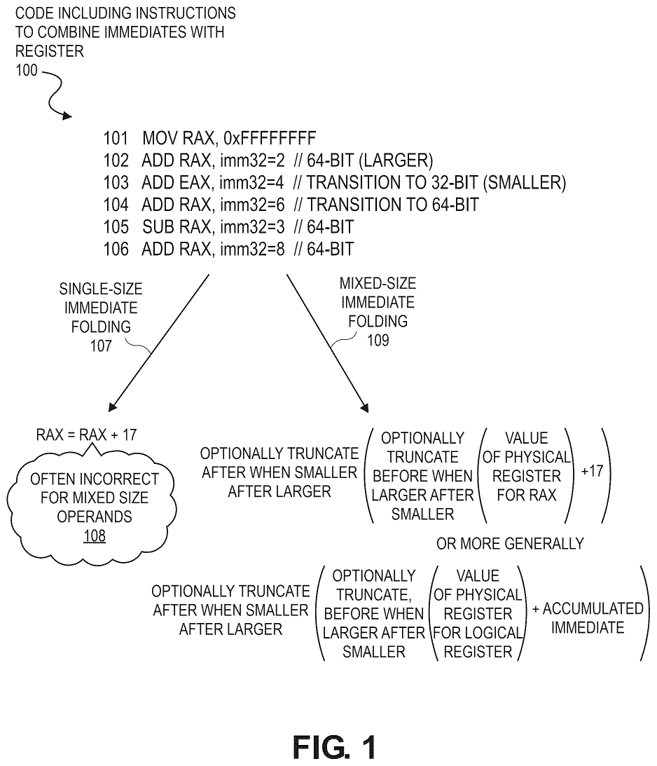

FIG. 1 illustrates a specific example of code 100 including a group of instructions to accumulate or combine their immediates with registers having different widths and contrasts an approach to perform single-size immediate folding 107 on the group of instructions with an embodiment of an approach to perform mixed-size immediate folding 109 on the group of instructions. Groups of instructions to combine their immediates with registers are used for various reasons, such as, for example, when an immediate value is added to a register during each iteration of a loop.

The code includes a MOV instruction 101 to move a value into a register referred to as RAX. The register RAX is a 64-bit general-purpose register in the x86 instruction set architecture. The register RAX broadly represents a general-purpose register or logical register for a 64-bit or other wider operand size in the x86 instruction set architecture. In this example, the value is the hexadecimal value 0xFFFFFFFF, although this is just one illustrative example. The hexadecimal value 0xFFFFFFFF written in binary representation is 11111111111111111111111111111111. The code also includes an ADD instruction 102 to add a 32-bit immediate (imm32), in this example having a value of two, to the register RAX. The code also includes an ADD instruction 103 to add a 32-bit immediate (imm32), in this example having a value of four, to the register EAX. The register EAX broadly represents a general-purpose register or logical register for a 32-bit or other narrower operand size in the x86 instruction set architecture. There is also AX for a 16-bit operand size, and AH and AL for an 8-bit operand size. The ADD instruction 103 truncates (e.g., zeroes) bits [63:32] of the register RAX while keeping bits [31:0] corresponding to the register EAX.

Notice that the ADD instruction 103 operates on a 32-bit register or operand size whereas the ADD instruction 102 operates on a 64-bit register or operand size. That is, these instructions operate on mixed-sized registers, operands, or values. Also, notice that performing the ADD instruction 103 after the ADD instruction 102 is a transition from a 64-bit or other wider register or operand size to a 32-bit or other narrower register or operand size. The code also includes an ADD instruction 104 to add a 32-bit immediate (imm32), in this example having a value of six, to the register RAX. Notice that performing the ADD instruction 104 after the ADD instruction 103 is a transition from the 32-bit or other narrower register or operand size back to the 64-bit or other wider register or operand size. The code also includes an SUB instruction 105 to subtract a 32-bit immediate (imm32), in this example having a value of three, from the register RAX. This is done using the 64-bit or other wider register or operand size. The code also includes an ADD instruction 106 to add a 32-bit immediate (imm32), in this example having a value of eight, to the register RAX. This is also done using the 64-bit or other wider register or operand size.

The RAX and EAX registers represent architectural registers (e.g., architecturally-visible) registers that are visible to software and/or a programmer and/or are the registers indicated by instructions (e.g., the instructions 101 to 106) of the instruction set of the processor to identify operands. The registers may be implemented in different ways in different microarchitectures and are not limited to any particular type of design. Examples of suitable types of registers include, but are not limited to, dedicated physical registers, dynamically allocated physical registers using register renaming, and combinations thereof. When register renaming is used, the architectural registers represent logical registers and the dynamically allocated physical registers represent the corresponding or mapped physical registers.

In this specific example, the code includes instructions of the x86 instruction set architecture, and general-purpose registers of the x86 instruction set architecture, although other instruction set architectures similarly have instructions to add, subtract, or otherwise combine immediates with registers, and similarly have other general-purpose registers. As one example, certain ARMv8-A architecture and ARMv9-A architecture processors available from Arm Limited have an instruction “ADD (immediate)” that when executed causes the processors to add a register value and an optionally-shifted immediate value and write the result to a destination register. Such ARMv8-A and ARMv9-A architecture processors have 31 general-purpose registers, named R0 to R30. Each of these registers R0 to R30 may be accessed as either a 64-bit general-purpose register, respectively named X0 to X30 or as a 32-bit general-purpose register, respectively named W0 to W30. Also, in this specific example, 64-bit and 32-bit sized registers or operands are shown, although other sizes besides 64-bit and 32-bit may be used in other embodiments, such as, for example, 8-bit and/or 16-bit sizes. Similarly, other sized immediates may optionally be used instead of 32-bit immediates, such as, for example, 4-bit, 8-bit, or 16-bit immediates. This specific example shows a few types of instructions to combine immediates with a register, although there are also other types of instructions that immediate folding may be used on. A few other examples of suitable types of instructions include, but are not limited to, move type instructions (e.g., x86 MOV) instructions that effectively add an immediate of zero, stack push instructions, stack pop instructions, function call instructions, function return instructions, increment instructions, decrement instructions, instructions that sign extend instead of zero extend (e.g., the x86 instruction MOVSX), etc. For simplicity, the group of instructions to combine the immediates with the register are shown as being consecutive, although it is to be appreciated that they may optionally be interspersed among other instructions that simply are not shown because they are not involved in the immediate folding.

A conventional approach would be to execute or perform each of the instructions 102 through 106 separately or individually and to separately or individually add each of the immediates of the instructions 102 through 106 to the register. For example, each of the instructions 102 through 106 may be decoded, separately or individually executed by an execution unit, and the results of adding each of the respective immediates may be separately or individually retired or otherwise committed to architectural state. However, one drawback with this approach is that multiple instructions (e.g., in this example five, although there may either be more or less) need to be executed separately or individually, which tends to take relatively more time and/or tends to reduce performance.

An alternate approach is to use immediate folding. The immediate folding generally involves adding, subtracting, or otherwise combining the immediates of the group of instructions into a combined or accumulated immediate. For example, the immediates may be combined in the register renaming stage of the processor. Then, the accumulated immediate may be combined with the register instead of combining each of the immediates making up the accumulated immediate separately or individually with the register. This effectively folds or collapses the group of instructions into generation of the accumulated immediate and a single combination of the accumulated immediate with the register. This reduces the number of instructions that need to be executed or performed (e.g., in the illustrated example effectively reducing the number of chained instructions that need to be executed from five to one), which tends to take relatively less time and/or tends to increase performance.

Referring again to FIG. 1, a single-size immediate folding approach 107 is shown. The single-size immediate folding would generally be appropriate if all instructions of the group of instructions that combine their immediates with the register used the same sized register or operand. In this particular example, the single-size immediate folding approach may represent adding seventeen (e.g., 17=2+4+6+3+8) to the register RAX.

However, as shown at 108, such single-size immediate folding is often incorrect when immediate folding is performed on instructions having mixed-sized registers and/or operands (e.g., both 32-bit and 64-bit registers or operands). An addition with a smaller or narrower operand size may perform the addition and may truncate (e.g., zero extend or sign extend) most significant bits of the result that are more significant than the operand size. Representatively, for the example code, the ADD instruction 103 may perform a 32-bit addition (e.g., 0xFFFFFFFF+2+4), retain the least significant bits [31:0] of the addition result, and zero the most significant bits [63:32] of the result. As a result of this truncation or zeroing of the most significant bits, the result of the single-size immediate folding 107 may not always accurately represent the actual group of instructions on which the single-size immediate folding is performed, since in some cases there may be integer overflow within these additions (e.g., which may depend on the initial value of the register (e.g., RAX in this example). For example, this problem may surface when chaining a wider (e.g., 64-bit) addition on top of a narrower (e.g., 32-bit) addition, where the narrower addition overflows, but the truncation or zero-extension removes the overflowed bit. The following example illustrates this:

$$MOV EAX , \text{} 0 xFFFFFFFF // EAX = 11111111111111111111111111111111$$

$$ADD EAX , 1 // ( EAX = 0 x 00000000 )$$

$$ADD RAX , 1 // ( EAX = 0 x 00000000 \_ 00000001 )$$

This code is incrementing register RAX twice, but with two different operation sizes. The intended result of the additions, where zx32 represents zeroing the most significant 32 bits, is:

$$zx 32 ( 0 xFFFFFFFF + 1 ) + 1 = 0 x 00000000 \_ 00000001$$

The single-size immediate folding 107 may try to represent this sequence of operations as a register value plus one accumulated immediate value. However, the truncation causes it to sometimes, but not always, be possible to correctly represent the value with just one lumped sum, even with truncation. This is shown as follows:

$$0 xFFFFFFFF + 2 = 0 x 00000000 \_ 00000001$$

$$zx 32 ( 0 xFFFFFFFF ) + 2 = 0 x 00000000 \_ 00000001$$

$$zx 32 ( 0 xFFFFFFFF + 2 ) = 0 x 00000000 \_ 00000001$$

The first approach uses no truncation, the second approach uses “truncate before addition,” and the third/last approach uses “truncate after addition.” For this example, the third/last approach coincidentally provides the correct value, although “truncate after addition” does not always provide the correct value.

Referring again to FIG. 1, a mixed-size immediate folding approach 109 is also shown. The mixed-size immediate folding approach, for this specific example, includes optionally truncating a value of a physical register for RAX before the addition or combination of the accumulated immediate value of 17, and optionally truncating a result of adding or combining the value of the physical register for RAX with the accumulated immediate value of 17. Examples of suitable ways of truncating include, but are not limited to, zero extending through the most significant bits, sign extending through the most significant bits, chopping off the most significant bits, or otherwise discarding the most significant bits. More generally, the mixed-size immediate folding approach includes optionally truncating a value of a physical register for a logical register (e.g., an architecturally-visible general-purpose register) before the addition or combination with the accumulated immediate, and optionally truncating a result of adding or combining the value of a physical register for a logical register with the accumulated immediate. It is not required to use both the truncation before and the truncation after. Only one truncation may optionally be used, since truncation before the combination with the accumulated immediate, then combination of the accumulated immediate, and then truncation after the combination with the accumulated immediate should produce the same result as first combining the immediate and then truncating, so using both truncations may be redundant and unnecessary.

When performing immediate folding for a logical register and operand sizes of a plurality of different widths (e.g., 32-bit and 64-bit widths) there are some cases where a narrower (e.g., 32-bit) accumulation or combination of an immediate occurs after one or more wider (e.g., 64-bit) accumulations or combinations of immediates. In some embodiments, correct results can be achieved in such cases by first performing the addition, subtraction, or other accumulation or combination of the accumulated immediate to generate a combined value and then (e.g., after the accumulation or combination) truncating bits of the combined value more significant than the narrower width. For example, only the lowest order 32 bits of the combined value may be retained and the most significant 32-bits of the combined result may be discarded or otherwise truncated (e.g., by zero extension, sign extension, etc.). Consequently, representing one or more of wider (e.g., 64-bit) additions followed by a narrower (e.g., 32-bit) addition should always be correctly represented by a lump sum of all the immediates followed by a truncation (e.g., zero extension or sign extension) down to the narrower number of bits (e.g., 32 bits). In some embodiments, the truncation approach (e.g., sign extension, zero extension, etc.) may optionally be specified and used based on or consistent with the truncation approach used by a corresponding instruction in the immediate folding chain (e.g., whether it uses sign extension or zero extension). While only described for one operand or register size decrease, this approach may also optionally be used for additional operand or register size decreases (e.g., when transitioning from 32-bit to 16-bit or 8-bit operands or registers).

When performing such immediate folding for a logical register and operand sizes of a plurality of different widths (e.g., 32-bit and 64-bit widths) there are other cases where a wider (e.g., 64-bit) accumulation or combination of an immediate occurs after one or more narrower (e.g., 32-bit) accumulations or combinations of immediates. In some embodiments, correct results may be achieved in many or most such cases by first truncating (e.g., zero extending, sign extending, or otherwise discarding most significant bits) the value of the physical register down to the narrower width and then (e.g., after truncating these bits) performing the addition, subtraction, or other accumulation or combination of the accumulated immediate. For example, the logical register may be represented as a truncation (e.g., a sign extension or zero extension) of the value of the physical register down to the narrower width (e.g., 32-bits) followed by an addition with the accumulated immediate. This approach may be used each time there is an increase or transition to a larger size, such as, for example, when transitioning from 8-bit or 16-bit to 32-bit operands or registers, etc. In some embodiments, a truncation approach (e.g., sign extension or zero extension) may optionally be specified and used based on a truncation approach used by a corresponding instruction in immediate folding chain (e.g., whether it uses sign extension or zero extension). This approach should provide the correct result in many or most cases but may not provide the correct result in all cases. Accordingly, in some embodiments, the result may optionally be checked for correctness, and a corrective action may be taken when the result is determined to be incorrect. By way of example, one such corrective action could be to flush the pipeline and redo the immediate accumulations or combinations. Embodiments of approaches to perform such verifications or checks will be discussed further below.

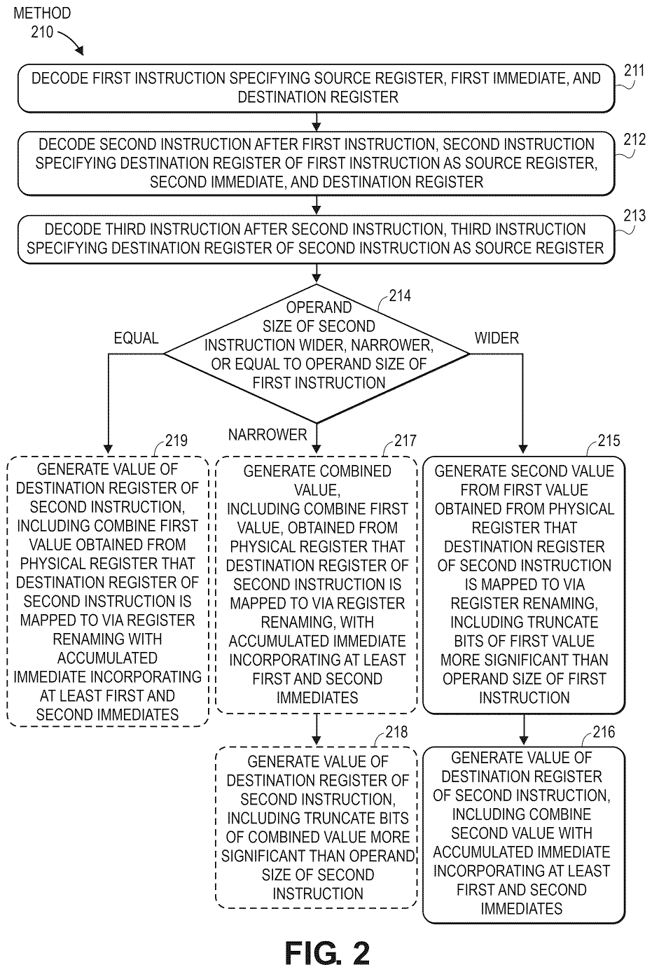

FIG. 2 is a block flow diagram of an embodiment of a method 210 of performing immediate folding for a logical register and operand sizes of different widths. In some embodiments, the method may be performed by a processor. In some embodiments, the processor may be a general-purpose processor (e.g., a general-purpose microprocessor or central processing unit (CPU) of the type used in desktop, laptop, or other computers). Alternatively, the processor may be a special-purpose processor. Examples of suitable special-purpose processors include, but are not limited to, graphics processors, artificial intelligence processors, machine-learning processors, co-processors, etc. In some embodiments, the processor may include (e.g., be disposed on) at least one integrated circuit or semiconductor die.

At block 211, a first instruction is received and decoded. The first instruction may specify a source register, a first immediate, and a destination register. In some embodiments, the first instruction has a first opcode indicating that the first immediate is to be combined with the source register of the first instruction.

At block 212, a second instruction is received and decoded after the first instruction. The second instruction may specify the destination register of the first instruction as a source register, a second immediate, and a destination register. In some embodiments, the second instruction has a second opcode indicating that the second immediate is to be combined with the source register of the second instruction. In some embodiments, the first and second instructions may be types of instructions that are combinable via immediate folding (e.g., the types previously mentioned for FIG. 1). In some embodiments, the destination registers of the first and second instructions are a same general-purpose register.

At block 213, a third instruction is received and decoded after the second instruction. The third instruction may specify the destination register of the second instruction as a source register. By way of example, the third instruction may be any of a wide variety of an arithmetic and/or logical instructions that use the value of the destination register of the second instruction to generate a result.

At block 214, a determination is made whether an operand size of the second instruction is wider than, narrower than, or equal to, an operand size of the first instruction. Based on this determination different operations associated with the third instruction may be performed.

When the operand size of the second instruction is wider than the operand size of the first instruction (e.g., the determination at block 214 is “WIDER”), then the method may advance to block 215. In some embodiments, the second operand size is 64 bits and the first operand size is one of 8 bits, 16 bits, and 32 bits. At block 215, a second value may be generated from a first value obtained from a physical register that the destination register of the second instruction is mapped to via register renaming. The generation of the second value may include truncating bits of the first value more significant than the operand size of the first instruction (e.g., by zero extension, sign extension, etc.). Then, at block 216, a value of the destination register of the second instruction may be generated. This may include combining the second value with an accumulated immediate incorporating at least the first immediate and the second immediate (e.g., as well as immediates of any other instructions folded into the immediate folding chain).

Referring again to block 214, when the operand size of the second instruction is narrower than the operand size of the first instruction (e.g., the determination at block 214 is “NARROWER”), then the method may optionally advance to optional block 217. In some embodiments, the first operand size is 64 bits and the second operand size is one of 8 bits, 16 bits, and 32 bits. At optional block 217, a combined value may be generated by combining a first value, obtained from a physical register that the destination register of the second instruction is mapped to via register renaming, with an accumulated immediate incorporating at least the first immediate and the second immediate (e.g., as well as immediates of any other instructions folded into the immediate folding chain). Then, at optional block 218, the value of the destination register of the second instruction may be generated by truncating bits of the combined value more significant than the operand size of the second instruction (e.g., by zero extension, sign extension, etc.).

Referring again to block 214, when the operand size of the second instruction is equal to the operand size of the first instruction (e.g., the determination at block 214 is “EQUAL”), then the method may optionally advance to optional block 219. At optional block 219, a value of the destination register of the second instruction may be generated by combining a first value obtained from a physical register that the destination register of the second instruction is mapped to via register renaming with an accumulated immediate incorporating at least the first immediate and the second immediate (e.g., as well as immediates of any other instructions folded into the immediate folding chain).

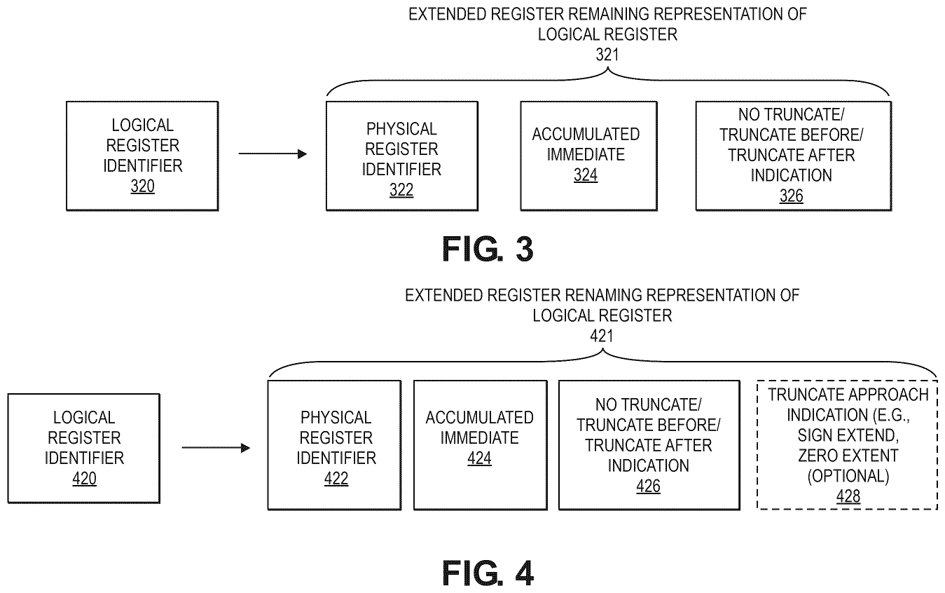

FIG. 3 is a block diagram illustrating that a logical register identifier 320 may be mapped to a first embodiment of an extended register renaming representation 321 of the logical register. The first embodiment of the extended register renaming representation includes a physical register identifier 322, an accumulated immediate 324, and a no truncate/truncate before/truncate after indication 326. In some embodiments, the logical register identifier may be mapped to the extended register renaming representation in a corresponding entry of a register renaming table and/or register alias table to be used for register renaming. Such entries may optionally be used for an entire set of logical registers (e.g., all general-purpose registers) or optionally only a subset of the entire set of logical registers (e.g., optionally only some of the logical registers may allow and/or support immediate folding). The logical register identifier, the physical register identifier, the accumulated immediate, and the no truncate/truncate before/truncate after indication may represent either fields of the entry or the contents stored in those fields. If immediate folding is not being used for the logical register, then conventionally in register renaming only the physical register identifier may be used. If single-size immediate folding (e.g., immediate folding on a single sized register or operand) is being used for the logical register, then the accumulated immediate may also be used. In this case, the logical register is represented and/or interpreted to be based on the contents of the identified physical register in combination with (e.g., through addition, subtraction, etc.) the accumulated immediate.

If mixed-size immediate folding (e.g., immediate folding on two or more sizes of registers or operands) is being used for the logical register, then both the accumulated immediate and the no truncate/truncate before/truncate after indication may also be used. In such cases, the logical register may be represented and/or interpreted to be based on the contents of the identified physical register in combination with (e.g., through addition, subtraction, etc.) the accumulated immediate and either no truncation or a truncation operation (e.g., zero extension, sign extension, or other approach to discard most significant bits) that is to be performed either before or after the combination of the contents of the identified physical register and the accumulated immediate based on and/or as indicated by the no truncate/truncate before/truncate after indication. For example, the no truncate/truncate before/truncate after indication may be a plurality of bits that may have a first value (e.g., a binary value ‘00’ according to one possible convention) to indicate that no truncation operation is to be used, a second value (e.g., a binary value ‘01’ according to one possible convention) to indicate that a truncation operation is to happen before the combination, or a third still different value (e.g., a binary value of ‘10’ according to one possible convention) to indicate that the truncation operation is to happen after the combination. The accumulated immediate and the no truncate/truncate before/truncate after indication represent an extension to the representation of the identified logical register that allow immediate folding to be performed on mixed-sized registers or operands (e.g., both 32-bit and 64-bit).

FIG. 4 is a block diagram illustrating that a logical register identifier 420 may be mapped to a second embodiment of an extended register renaming representation 421 of the logical register. The second embodiment of an extended register renaming representation includes a physical register identifier 422, an accumulated immediate 424, a no truncate/truncate before/truncate after indication 426, and an optional truncate approach indication 428. Except for the addition of the optional truncate approach indication 428, the extended register renaming representation 421 may be similar to or the same as the extended register renaming representation 321 already described for FIG. 3. If mixed-size immediate folding is being used, then the identified logical register may be represented and/or interpreted to be based on the contents of the identified physical register in combination with (e.g., through addition, subtraction, etc.) the accumulated immediate 424 and a truncation operation according to a truncation approach (e.g., zero extension, sign extension, or another approach to discard most significant bits) indicated by the truncate approach indication 428, which is either not to be performed or is to be performed either before or after the combination of the contents of the identified physical register and the accumulated immediate as indicated by the no truncate/truncate before/truncate after indication 426. For example, the truncation approach indication may be one or more bits that may have a first value (e.g., a single bit set to binary one according to one possible convention) to indicate that zero extension is to be used as the truncation approach or a second different value (e.g., the single bit cleared to binary zero) to indicate that sign extension is to be used as the truncation approach. The truncate approach indication represents a further optional extension to the representation of the identified logical register that allows immediate folding to be performed for instructions (e.g., both ADD and MOVSX) that use different truncation approaches (e.g., both zero extension and sign extension).

In some embodiments, after each instruction is folded into the immediate chain, the mixed-size immediate folding approach may be used to create, maintain, or update an extended register renaming representation of the logical register (e.g., RAX, EAX, etc.) such as the representations 321 and 421 shown for FIGS. 3-4. These extended register renaming representations may be preserved (e.g., in an entry of a register renaming table, an entry of a register alias table, etc.), but not used to evaluate the value of the logical register, until another instruction (e.g., a multiply instruction, a shift instruction, other arithmetic and/or logical instruction) needs or consumes the value of that logical register (e.g., RAX, EAX, etc.) to perform a computation (e.g., specifies the logical register as a source operand). Then, the extended register renaming representation may be used to generate the value of the logical register so that the value of the logical register can be provided as input to an execution unit used to perform that computation (e.g., multiply the value of the logical register by another value, shift the value of the logical register, etc.). Until such a time, the extended register renaming representation represents or preserves the value of the logical register so that the value can be calculated when needed. These extended register renaming representations represent what the value of these logical registers should be. The physical register values are not computed at register renaming time, but we can still manipulate these expressions or representations of the values of these logical registers. When an instruction needs to use or consume the value of the logical register then these expressions may be evaluated at instruction execution time when the physical register values are known.

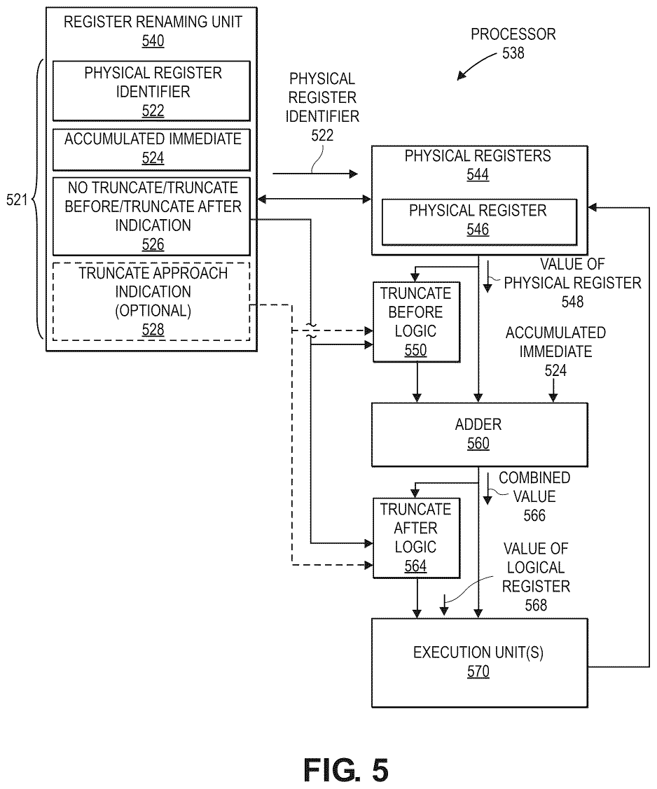

FIG. 5 is a block diagram of an example embodiment of a processor 538 to generate a value 568 of a logical register based on an extended register renaming representation 521 of the logical register. Only a portion of the processor relevant to generation of the value of the logical register using the extended register renaming representation is shown, although the processor may optionally be the same as or similar to other processors disclosed further below (e.g., core 890, have register architecture 1000, etc.). The processor may be of the types previously described (e.g., a general-purpose processor, a special-purpose processor of the types already described, CISC, RISC, etc.)

The processor includes a register renaming unit 540 and a pool or other set of physical registers 544. The register renaming unit may be operative to map or rename architecturally-visible registers or other logical registers (e.g., general-purpose registers, such as, for example, EAX, RAX, etc.) to corresponding physical registers of the set of physical registers. The register renaming unit includes (e.g., in an entry of a register renaming table) the extended register renaming representation 521 of the logical register. The extended register renaming representation includes a physical register identifier 522, an accumulated immediate 524, a no truncate/truncate before/truncate after indication 526, and an optional truncate approach indication 528. Each of these may optionally be the same as or similar to those already described for FIGS. 3-4.

At an appropriate time, such as, for example, when the value of the logical register is to be used in a computation during the execution of an instruction indicating the logical register, the extended register renaming representation 521 of the logical register may be used to generate the value 568 of the logical register. This may effectively represent “unfolding” the extended representation generated during immediate folding. The register renaming unit may output or provide the physical register identifier 522 to the set of physical registers. The physical register identifier may identify a corresponding physical register 546 of the set of physical registers. The identified physical register may have a value representative of the value of the corresponding logical register prior to starting the immediate folding.

The value of the identified physical register may be output or provided from the set of physical registers to either a truncate before circuitry or other logic 550 or an adder (e.g., addition circuitry) 560 based on and/or according to the no truncate/truncate before/truncate after indication 526. If the no truncate/truncate before/truncate after indication indicates that a truncation operation is to be performed before combining the accumulated immediate (e.g., similar to what was described for block 214 of FIG. 2), then the value of the physical register may be output or provided to the truncate before logic. The truncate before logic may perform a truncation operation on the value of the physical register to truncate it from a wider size (e.g., 64-bits) to a narrower size (e.g., 32-bits) to generate a truncated value of the physical register. In some embodiments, an approach used for the truncation operation (e.g., zero extension, sign extension, another approach to discard most significant bits) may be flexibly controlled according to the truncate approach indication 528. Alternatively, the approach may optionally be provided in a control and/or configuration register, or only a single approach (e.g., only zero extension, only sign extension, etc.) may optionally be supported and used. By way of example, the truncation operation may generate a 64-bit truncated value that includes bits [31:0] of the starting 64-bit value of the physical register 546 and either zeroes in bits [63:32] or the sign (e.g., the binary value) of bit-31 of the starting 64-bit value in bits [63:32] based on and/or according to the optional truncation approach indication 528. Then, the truncated value of the physical register may be output or provided to the adder 560.

Alternatively, if the no truncate/truncate before/truncate after indication does not indicate that the truncation operation is to be performed before combining the value of the physical register with the accumulated immediate, then the value of the physical register may be provided to the adder. The value of the accumulated immediate 524 may also be provided from the register renaming unit to the adder. The adder is an example of combination circuitry or other logic to add, subtract, arithmetically combine, or otherwise combine either the value of the physical register or the truncated value of the physical register with the accumulated immediate to generate a combined value 566.

The combined value 566 may be output or provided from the adder to either a truncate after circuitry or other logic 564 or one or more execution units 570 based on and/or according to the no truncate/truncate before/truncate after indication 526. If the no truncate/truncate before/truncate after indication indicates that a truncation operation is to be performed after combining the value of the physical register, or the truncated value of the physical register, with the accumulated immediate (e.g., similar to what was described for block 216 of FIG. 2), then the combined value 566 may be provided to the truncate after logic. The truncate after logic may perform a truncation operation on the combined value to truncate it from a wider size (e.g., 64-bits) to a narrower size (e.g., 32-bits) to generate a value 568 of the logical register. In some embodiments, an approach used for the truncation operation (e.g., truncation, zero extension, sign extension, another approach to discard most significant bits) may be flexibly controlled according to the truncate approach indication 528. Alternatively, the approach may optionally be provided in a control and/or configuration register, or only a single approach (e.g., only zero extension or only sign extension) may optionally be used. By way of example, the truncation operation may generate a 64-bit value of the logical register that includes bits [31:0] of the 64-bit starting combined value 566 and either zeroes in bits [63:32] or the sign (e.g., the binary value) of bit-31 of the 64-bit starting combined value in bits [63:32] based on and/or according to the optional truncate approach indication 528.

Alternatively, if the no truncate/truncate before/truncate after indication does not indicate that the truncation operation is to be performed after combining the value of the physical register, or the truncated value of the physical register, with the accumulated immediate, then the combined value 566 may be provided as the value 568 of the logical register to the one or more execution units 570. Without limitation, the one or more execution units may use the value of the logical register (e.g., the value of an architecturally-visible general-purpose register) to compute a result or value. The one more execution units may include one or more of a multiplier, an adder, an arithmetic unit, a logic unit, an arithmetic logic unit (ALU), an address generation unit, or other types of execution units known in the arts.

FIG. 5 shows one set of circuitry to generate a value for a logical register. A processor may also include one or more additional sets of such circuitry to generate another value for another logical register. For example, this may be the case if two logical registers are to be provided to an execution unit.

As mentioned above, in cases where a wider (e.g., 64-bit) accumulation or combination of an immediate occurs after one or more narrower (e.g., 32-bit) accumulations or combinations of immediates, the correct result may be achieved in many or most cases by first discarding or otherwise truncating bits of the value of the physical register down to the narrower width and then performing the addition or other combination of the accumulated immediate. However, this approach is not guaranteed to provide the correct result in all cases. Accordingly, in some embodiments, the approach may be used speculatively assuming that the result will be correct, and then the result may optionally be checked for correctness and a corrective action may be taken in the uncommon case when the result is determined to be incorrect.

In some embodiments, the check for correctness may only need to be performed for the first wider (e.g., 64-bit) accumulation or combination occurring after one or more narrower (e.g., 32-bit accumulations. If this first wider (e.g., 64-bit) accumulation or combination is correct, then additional subsequent wider (e.g., 64-bit) accumulations or combinations will also be guaranteed to be correct. In other words, whenever there is a chain of accumulations or combinations with two different sizes, the only place where correctness is not guaranteed and needs to be checked is the first accumulation or combination at the wider width (e.g., when the accumulation chain switches from 32-bit to 64-bit accumulations). Only needing to check this first wider (e.g., 64-bit) accumulation or combination instead of the additional subsequent wider (e.g., 64-bit) accumulations or combinations may help to reduce the number of verification instructions needed, which in turn helps to improve performance.

After one or more narrower (e.g., 32-bit) accumulations the value of the logical register may be represented as truncate(register+A), where A is the accumulated immediate for the immediates accumulated so far. Subsequently, after performing a wider (e.g., 64-bit) accumulation with an immediate have a value B, the value of the logical register may be represented as truncate(register+A)+B which the approach may speculate may be correctly represented as truncate(register)+(A+B). However, due to the truncation, these two representations are not always equal. Accordingly, some embodiments may verify that they are equal. Since the addition of B is just a wider (e.g., 64-bit) non-truncated addition in each of these two representations, the verification that truncate(register+A)+B is equal to truncate(register)+(A+B) is equivalent to verifying that truncate(register+A) is equal to truncate(register)+A. In some embodiments, the verification may optionally be performed by performing addition in each of the two ways prescribed by the two representations (e.g., using two adders). For example, a real addition instruction may be issued to check whether the actual result of the addition (once the value of the register is known) is equal to the truncated register plus the lumped sum of the immediate operands in the chain. In other embodiments, the verification may optionally be performed by checking whether the source operand of the addition (register+A) overflows at the narrower (e.g., 32 bit) width. This check for overflow may optionally be performed through reuse of an existing unfolding adder (e.g., the adder 560) to reduce the amount of additional hardware needed to perform the check. This verification may be performed off the critical path rather than within a timing-critical single-cycle loop.

If the two results are not equal (e.g., the verification fails), then in some embodiments the pipeline may be flushed, the immediate folding chain may be broken, and the addition or accumulation may be performed or redone using a real wider (e.g., 64-bit) addition or accumulation instruction to generate the result of truncate(register+A)+B. This may cause some performance loss but is expected to occur relatively infrequently.

In some embodiments, to help reduce or limit such performance losses, circuitry or other logic may be included to predict or estimate when the results will not be equal and/or when the verification will fail. For example, the circuitry or other logic may track instructions that produce incorrect results and/or lead to verification failures. One example of such circuitry or logic is a Bloom filter, similar type of filter, or other logic to implement a probabilistic data structure to remember or record instructions that have had incorrect results or failed verification in the past. When the Bloom filter or other such logic predicts an instruction is likely to fail verification then immediate folding may optionally not be attempted for that instruction (e.g., the immediate chain may be broken before the instruction). This may help to avoid some of the performance loss due to repeatedly failing verification for the same instruction. The Bloom filter or other such logic may optionally be cleared periodically or occasionally.

To further illustrate certain concepts, consider a detailed example of how the extended register renaming representation may be created and used for instructions 101 to 106 of FIG. 1.

TABLE 1
Example for instructions 101 to 104.

| | | | Truncate | |
|---|---|---|---|---|
| | | | Before/After and | |
| | | | Approach | |
| | | | (e.g., None, zx32 | |
| | | | before, zx32 after, | Consumer of RAX |
| After | Physical | Accumulated | sx32 before, sx32 | does this when |
| instruction: | register | Immediate | after) | reading the operand: |
| 101 (Not | p10 | 0 | None | p10 (=ffffffff) |
| folded) | (holds | | | |
| | 0xffffffff) | | | |
| 102 | p10 | +2 | None | p10 + 2 |
| | | | | (=1_00000001) |
| 103 | p10 | +6 | Zero-extend from 32 | zx32(p10 + 6) |
| | | | bits, after addition | (=00000005) |
| 104 | p10 | +12 | Zero-extend from 32 | zx32(p10) + 12 |
| | | | bits, before addition | (=1_00000000b) |

Instruction 104 is a 64-bit addition fed from a zx32-after source operand. Consequently, a verification of the correctness of the result of instruction 104 may be performed. In this example, the result of instruction 104 is incorrect since p10+6 overflows. So, the pipeline may be flushed of instruction 104 and all later instructions. Instruction 104 may be executed again without immediate folding to generate the correct value. The correct answer is 0000000b not 1_0000000b. This may optionally produce a new physical register (e.g., p11).

TABLE 2
Example of redoing instructions 104 to 106.

| | | | Truncate | Consumer of |
|---|---|---|---|---|
| | | | Before/ | RAX does this |
| After | Physical | Accumulated | After and | when reading the |
| instruction: | register | Immediate | Approach | operand: |
| 104 | p11 (holds | 0 | None | A real addition |
| | 0x0000000b) | | | instruction was |
| | | | | executed to |
| | | | | compute p11 = |
| | | | | 0000000b |
| 105 | p11 | −3 | None | p11 − 3 |
| | | | | (=00000008) |
| 106 | p11 | +5 | None | p11 + 5 |
| | | | | (=00000010) |

### Example Computer Architectures

Detailed below are descriptions of example computer architectures. Other system designs and configurations known in the arts for laptop, desktop, and handheld personal computers (PC)s, personal digital assistants, engineering workstations, servers, disaggregated servers, network devices, network hubs, switches, routers, embedded processors, digital signal processors (DSPs), graphics devices, video game devices, set-top boxes, micro controllers, cell phones, portable media players, hand-held devices, and various other electronic devices, are also suitable. In general, a variety of systems or electronic devices capable of incorporating a processor and/or other execution logic as disclosed herein are suitable.

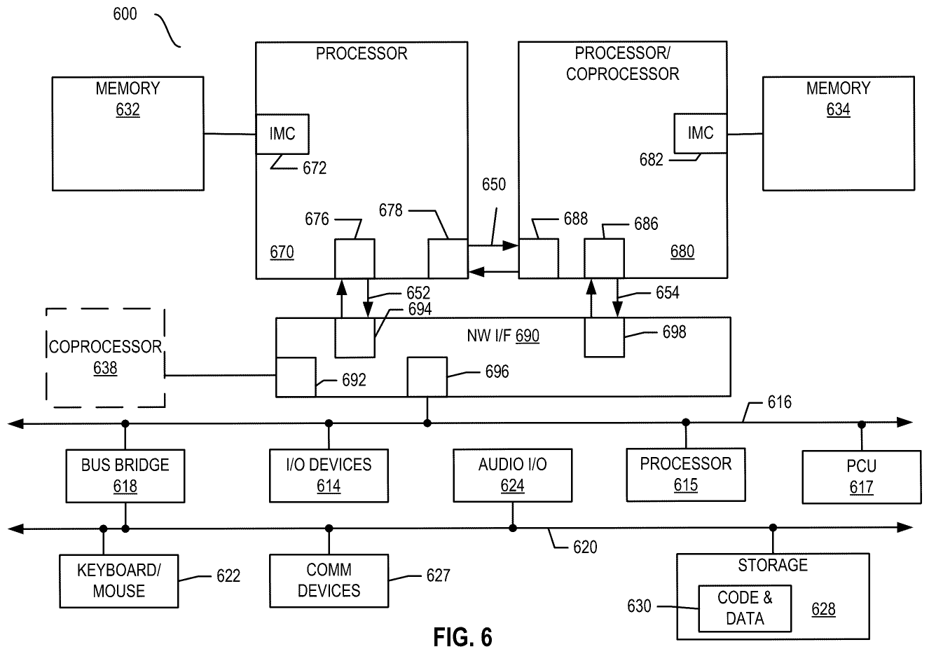

FIG. 6 illustrates an example computing system. Multiprocessor system 600 is an interfaced system and includes a plurality of processors or cores including a first processor 670 and a second processor 680 coupled via an interface 650 such as a point-to-point (P-P) interconnect, a fabric, and/or bus. In some examples, the first processor 670 and the second processor 680 are homogeneous. In some examples, the first processor 670 and the second processor 680 are heterogenous. Though the example system 600 is shown to have two processors, the system may have three or more processors, or may be a single processor system. In some examples, the computing system is a system on a chip (SoC).

Processors 670 and 680 are shown including integrated memory controller (IMC) circuitry 672 and 682, respectively. Processor 670 also includes interface circuits 676 and 678; similarly, second processor 680 includes interface circuits 686 and 688. Processors 670, 680 may exchange information via the interface 650 using interface circuits 678, 688. IMCs 672 and 682 couple the processors 670, 680 to respective memories, namely a memory 632 and a memory 634, which may be portions of main memory locally attached to the respective processors.

Processors 670, 680 may each exchange information with a network interface (NW I/F) 690 via individual interfaces 652, 654 using interface circuits 676, 694, 686, 698. The network interface 690 (e.g., one or more of an interconnect, bus, and/or fabric, and in some examples is a chipset) may optionally exchange information with a coprocessor 638 via an interface circuit 692. In some examples, the coprocessor 638 is a special-purpose processor, such as, for example, a high-throughput processor, a network or communication processor, compression engine, graphics processor, general purpose graphics processing unit (GPGPU), neural-network processing unit (NPU), embedded processor, or the like.

A shared cache (not shown) may be included in either processor 670, 680 or outside of both processors, yet connected with the processors via an interface such as P-P interconnect, such that either or both processors' local cache information may be stored in the shared cache if a processor is placed into a low power mode.

Network interface 690 may be coupled to a first interface 616 via interface circuit 696. In some examples, the first interface 616 may be an interface such as a Peripheral Component Interconnect (PCI) interconnect, a PCI Express interconnect or another I/O interconnect. In some examples, the first interface 616 is coupled to a power control unit (PCU) 617, which may include circuitry, software, and/or firmware to perform power management operations regarding the processors 670, 680 and/or co-processor 638. PCU 617 provides control information to a voltage regulator (not shown) to cause the voltage regulator to generate the appropriate regulated voltage. PCU 617 also provides control information to control the operating voltage generated. In various examples, PCU 617 may include a variety of power management logic units (circuitry) to perform hardware-based power management. Such power management may be wholly processor controlled (e.g., by various processor hardware, and which may be triggered by workload and/or power, thermal or other processor constraints) and/or the power management may be performed responsive to external sources (such as a platform or power management source or system software).

PCU 617 is illustrated as being present as logic separate from the processor 670 and/or processor 680. In other cases, PCU 617 may execute on a given one or more of cores (not shown) of processor 670 or 680. In some cases, PCU 617 may be implemented as a microcontroller (dedicated or general-purpose) or other control logic configured to execute its own dedicated power management code, sometimes referred to as P-code. In yet other examples, power management operations to be performed by PCU 617 may be implemented externally to a processor, such as by way of a separate power management integrated circuit (PMIC) or another component external to the processor. In yet other examples, power management operations to be performed by PCU 617 may be implemented within BIOS or other system software.

Various I/O devices 614 may be coupled to first interface 616, along with a bus bridge 618 which couples first interface 616 to a second interface 620. In some examples, one or more additional processor(s) 615, such as coprocessors, high throughput many integrated core (MIC) processors, GPGPUs, accelerators (such as graphics accelerators or digital signal processing (DSP) units), field programmable gate arrays (FPGAs), or any other processor, are coupled to first interface 616. In some examples, the second interface 620 may be a low pin count (LPC) interface. Various devices may be coupled to second interface 620 including, for example, a keyboard and/or mouse 622, communication devices 627 and storage circuitry 628. Storage circuitry 628 may be one or more non-transitory machine-readable storage media as described below, such as a disk drive or other mass storage device which may include instructions/code and data 630 and may implement the storage 'ISAB03 in some examples. Further, an audio I/O 624 may be coupled to second interface 620. Note that other architectures than the point-to-point architecture described above are possible. For example, instead of the point-to-point architecture, a system such as multiprocessor system 600 may implement a multi-drop interface or other such architecture.

### Example Core Architectures, Processors, and Computer Architectures

Processor cores may be implemented in different ways, for different purposes, and in different processors. For instance, implementations of such cores may include: 1) a general purpose in-order core intended for general-purpose computing; 2) a high-performance general purpose out-of-order core intended for general-purpose computing; 3) a special purpose core intended primarily for graphics and/or scientific (throughput) computing. Implementations of different processors may include: 1) a CPU including one or more general purpose in-order cores intended for general-purpose computing and/or one or more general purpose out-of-order cores intended for general-purpose computing; and 2) a coprocessor including one or more special purpose cores intended primarily for graphics and/or scientific (throughput) computing. Such different processors lead to different computer system architectures, which may include: 1) the coprocessor on a separate chip from the CPU; 2) the coprocessor on a separate die in the same package as a CPU; 3) the coprocessor on the same die as a CPU (in which case, such a coprocessor is sometimes referred to as special purpose logic, such as integrated graphics and/or scientific (throughput) logic, or as special purpose cores); and 4) a system on a chip (SoC) that may be included on the same die as the described CPU (sometimes referred to as the application core(s) or application processor(s)), the above described coprocessor, and additional functionality. Example core architectures are described next, followed by descriptions of example processors and computer architectures.

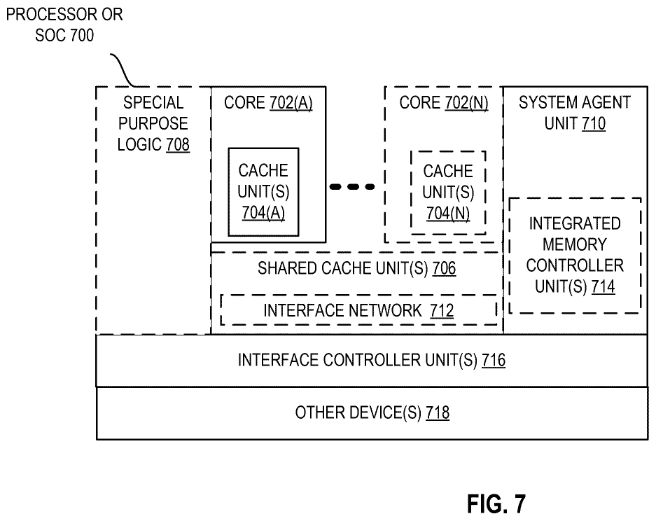

FIG. 7 illustrates a block diagram of an example processor and/or SoC 700 that may have one or more cores and an integrated memory controller. The solid lined boxes illustrate a processor 700 with a single core 702(A), system agent unit circuitry 710, and a set of one or more interface controller unit(s) circuitry 716, while the optional addition of the dashed lined boxes illustrates an alternative processor 700 with multiple cores 702(A)-(N), a set of one or more integrated memory controller unit(s) circuitry 714 in the system agent unit circuitry 710, and special purpose logic 708, as well as a set of one or more interface controller units circuitry 716. Note that the processor 700 may be one of the processors 670 or 680, or co-processor 638 or 615 of FIG. 6.

Thus, different implementations of the processor 700 may include: 1) a CPU with the special purpose logic 708 being integrated graphics and/or scientific (throughput) logic (which may include one or more cores, not shown), and the cores 702(A)-(N) being one or more general purpose cores (e.g., general purpose in-order cores, general purpose out-of-order cores, or a combination of the two); 2) a coprocessor with the cores 702(A)-(N) being a large number of special purpose cores intended primarily for graphics and/or scientific (throughput); and 3) a coprocessor with the cores 702(A)-(N) being a large number of general purpose in-order cores. Thus, the processor 700 may be a general-purpose processor, coprocessor or special-purpose processor, such as, for example, a network or communication processor, compression engine, graphics processor, GPGPU (general purpose graphics processing unit), a high throughput many integrated core (MIC) coprocessor (including 30 or more cores), embedded processor, or the like. The processor may be implemented on one or more chips. The processor 700 may be a part of and/or may be implemented on one or more substrates using any of several process technologies, such as, for example, complementary metal oxide semiconductor (CMOS), bipolar CMOS (BiCMOS), P-type metal oxide semiconductor (PMOS), or N-type metal oxide semiconductor (NMOS).

A memory hierarchy includes one or more levels of cache unit(s) circuitry 704(A)-(N) within the cores 702(A)-(N), a set of one or more shared cache unit(s) circuitry 706, and external memory (not shown) coupled to the set of integrated memory controller unit(s) circuitry 714. The set of one or more shared cache unit(s) circuitry 706 may include one or more mid-level caches, such as level 2 (L2), level 3 (L3), level 4 (L4), or other levels of cache, such as a last level cache (LLC), and/or combinations thereof. While in some examples interface network circuitry 712 (e.g., a ring interconnect) interfaces the special purpose logic 708 (e.g., integrated graphics logic), the set of shared cache unit(s) circuitry 706, and the system agent unit circuitry 710, alternative examples use any number of well-known techniques for interfacing such units. In some examples, coherency is maintained between one or more of the shared cache unit(s) circuitry 706 and cores 702(A)-(N). In some examples, interface controller unit's circuitry 716 couple the cores 702 to one or more other devices 718 such as one or more I/O devices, storage, one or more communication devices (e.g., wireless networking, wired networking, etc.), etc.

In some examples, one or more of the cores 702(A)-(N) are capable of multi-threading. The system agent unit circuitry 710 includes those components coordinating and operating cores 702(A)-(N). The system agent unit circuitry 710 may include, for example, power control unit (PCU) circuitry and/or display unit circuitry (not shown). The PCU may be or may include logic and components needed for regulating the power state of the cores 702(A)-(N) and/or the special purpose logic 708 (e.g., integrated graphics logic). The display unit circuitry is for driving one or more externally connected displays.

The cores 702(A)-(N) may be homogenous in terms of instruction set architecture (ISA). Alternatively, the cores 702(A)-(N) may be heterogeneous in terms of ISA; that is, a subset of the cores 702(A)-(N) may be capable of executing an ISA, while other cores may be capable of executing only a subset of that ISA or another ISA.

### Example Core Architectures—in-Order and Out-of-Order Core Block Diagram

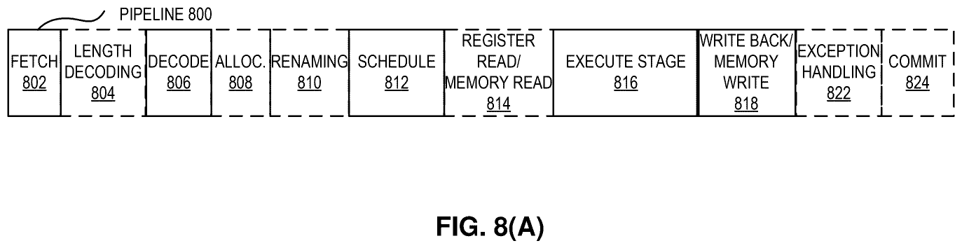

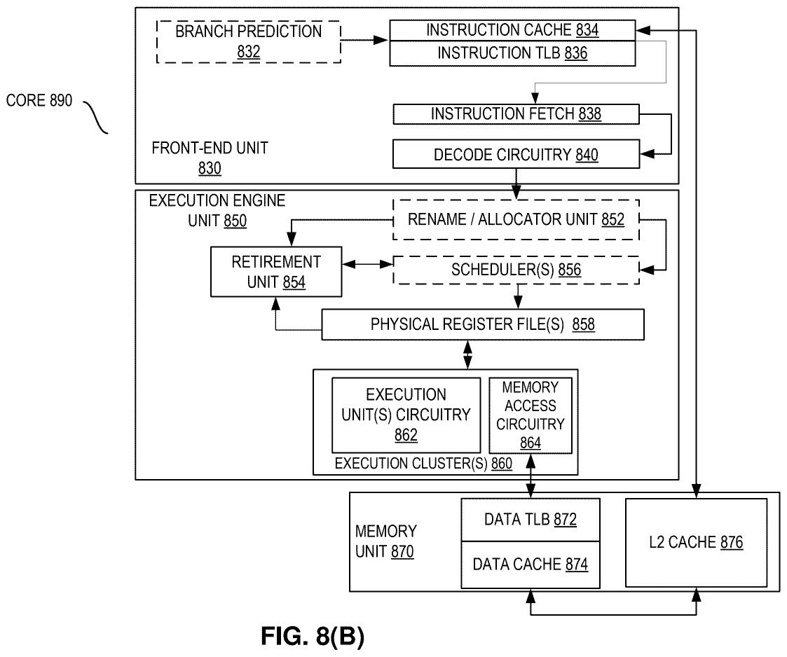

FIG. 8(A) is a block diagram illustrating both an example in-order pipeline and an example register renaming, out-of-order issue/execution pipeline according to examples. FIG. 8(B) is a block diagram illustrating both an example in-order architecture core and an example register renaming, out-of-order issue/execution architecture core to be included in a processor according to examples. The solid lined boxes in FIGS. 8(A)-(B) illustrate the in-order pipeline and in-order core, while the optional addition of the dashed lined boxes illustrates the register renaming, out-of-order issue/execution pipeline and core. Given that the in-order aspect is a subset of the out-of-order aspect, the out-of-order aspect will be described.

In FIG. 8(A), a processor pipeline 800 includes a fetch stage 802, an optional length decoding stage 804, a decode stage 806, an optional allocation (Alloc) stage 808, an optional renaming stage 810, a schedule (also known as a dispatch or issue) stage 812, an optional register read/memory read stage 814, an execute stage 816, a write back/memory write stage 818, an optional exception handling stage 822, and an optional commit stage 824. One or more operations can be performed in each of these processor pipeline stages. For example, during the fetch stage 802, one or more instructions are fetched from instruction memory, and during the decode stage 806, the one or more fetched instructions may be decoded, addresses (e.g., load store unit (LSU) addresses) using forwarded register ports may be generated, and branch forwarding (e.g., immediate offset or a link register (LR)) may be performed. In one example, the decode stage 806 and the register read/memory read stage 814 may be combined into one pipeline stage. In one example, during the execute stage 816, the decoded instructions may be executed, LSU address/data pipelining to an Advanced Microcontroller Bus (AMB) interface may be performed, multiply and add operations may be performed, arithmetic operations with branch results may be performed, etc.

By way of example, the example register renaming, out-of-order issue/execution architecture core of FIG. 8(B) may implement the pipeline 800 as follows: 1) the instruction fetch circuitry 838 performs the fetch and length decoding stages 802 and 804; 2) the decode circuitry 840 performs the decode stage 806; 3) the rename/allocator unit circuitry 852 performs the allocation stage 808 and renaming stage 810; 4) the scheduler(s) circuitry 856 performs the schedule stage 812; 5) the physical register file(s) circuitry 858 and the memory unit circuitry 870 perform the register read/memory read stage 814; the execution cluster(s) 860 perform the execute stage 816; 6) the memory unit circuitry 870 and the physical register file(s) circuitry 858 perform the write back/memory write stage 818; 7) various circuitry may be involved in the exception handling stage 822; and 8) the retirement unit circuitry 854 and the physical register file(s) circuitry 858 perform the commit stage 824.

FIG. 8(B) shows a processor core 890 including front-end unit circuitry 830 coupled to execution engine unit circuitry 850, and both are coupled to memory unit circuitry 870. The core 890 may be a reduced instruction set architecture computing (RISC) core, a complex instruction set architecture computing (CISC) core, a very long instruction word (VLIW) core, or a hybrid or alternative core type. As yet another option, the core 890 may be a special-purpose core, such as, for example, a network or communication core, compression engine, coprocessor core, general purpose computing graphics processing unit (GPGPU) core, graphics core, or the like.

The front-end unit circuitry 830 may include branch prediction circuitry 832 coupled to instruction cache circuitry 834, which is coupled to an instruction translation lookaside buffer (TLB) 836, which is coupled to instruction fetch circuitry 838, which is coupled to decode circuitry 840. In one example, the instruction cache circuitry 834 is included in the memory unit circuitry 870 rather than the front-end circuitry 830. The decode circuitry 840 (or decoder) may decode instructions, and generate as an output one or more micro-operations, micro-code entry points, microinstructions, other instructions, or other control signals, which are decoded from, or which otherwise reflect, or are derived from, the original instructions. The decode circuitry 840 may further include address generation unit (AGU, not shown) circuitry. In one example, the AGU generates an LSU address using forwarded register ports, and may further perform branch forwarding (e.g., immediate offset branch forwarding, LR register branch forwarding, etc.). The decode circuitry 840 may be implemented using various mechanisms. Examples of suitable mechanisms include, but are not limited to, look-up tables, hardware implementations, programmable logic arrays (PLAs), microcode read only memories (ROMs), etc. In one example, the core 890 includes a microcode ROM (not shown) or other medium that stores microcode for certain macroinstructions (e.g., in decode circuitry 840 or otherwise within the front-end circuitry 830). In one example, the decode circuitry 840 includes a micro-operation (micro-op) or operation cache (not shown) to hold/cache decoded operations, micro-tags, or micro-operations generated during the decode or other stages of the processor pipeline 800. The decode circuitry 840 may be coupled to rename/allocator unit circuitry 852 in the execution engine circuitry 850.

The execution engine circuitry 850 includes the rename/allocator unit circuitry 852 coupled to retirement unit circuitry 854 and a set of one or more scheduler(s) circuitry 856. The scheduler(s) circuitry 856 represents any number of different schedulers, including reservations stations, central instruction window, etc. In some examples, the scheduler(s) circuitry 856 can include arithmetic logic unit (ALU) scheduler/scheduling circuitry, ALU queues, address generation unit (AGU) scheduler/scheduling circuitry, AGU queues, etc. The scheduler(s) circuitry 856 is coupled to the physical register file(s) circuitry 858. Each of the physical register file(s) circuitry 858 represents one or more physical register files, different ones of which store one or more different data types, such as scalar integer, scalar floating-point, packed integer, packed floating-point, vector integer, vector floating-point, status (e.g., an instruction pointer that is the address of the next instruction to be executed), etc. In one example, the physical register file(s) circuitry 858 includes vector registers unit circuitry, writemask registers unit circuitry, and scalar register unit circuitry. These register units may provide architectural vector registers, vector mask registers, general-purpose registers, etc. The physical register file(s) circuitry 858 is coupled to the retirement unit circuitry 854 (also known as a retire queue or a retirement queue) to illustrate various ways in which register renaming and out-of-order execution may be implemented (e.g., using a reorder buffer(s) (ROB(s)) and a retirement register file(s); using a future file(s), a history buffer(s), and a retirement register file(s); using a register maps and a pool of registers; etc.). The retirement unit circuitry 854 and the physical register file(s) circuitry 858 are coupled to the execution cluster(s) 860. The execution cluster(s) 860 includes a set of one or more execution unit(s) circuitry 862 and a set of one or more memory access circuitry 864. The execution unit(s) circuitry 862 may perform various arithmetic, logic, floating-point or other types of operations (e.g., shifts, addition, subtraction, multiplication) and on various types of data (e.g., scalar integer, scalar floating-point, packed integer, packed floating-point, vector integer, vector floating-point). While some examples may include several execution units or execution unit circuitry dedicated to specific functions or sets of functions, other examples may include only one execution unit circuitry or multiple execution units/execution unit circuitry that all perform all functions. The scheduler(s) circuitry 856, physical register file(s) circuitry 858, and execution cluster(s) 860 are shown as being possibly plural because certain examples create separate pipelines for certain types of data/operations (e.g., a scalar integer pipeline, a scalar floating-point/packed integer/packed floating-point/vector integer/vector floating-point pipeline, and/or a memory access pipeline that each have their own scheduler circuitry, physical register file(s) circuitry, and/or execution cluster—and in the case of a separate memory access pipeline, certain examples are implemented in which only the execution cluster of this pipeline has the memory access unit(s) circuitry 864). It should also be understood that where separate pipelines are used, one or more of these pipelines may be out-of-order issue/execution and the rest in-order.

In some examples, the execution engine unit circuitry 850 may perform load store unit (LSU) address/data pipelining to an Advanced Microcontroller Bus (AMB) interface (not shown), and address phase and writeback, data phase load, store, and branches.

The set of memory access circuitry 864 is coupled to the memory unit circuitry 870, which includes data TLB circuitry 872 coupled to data cache circuitry 874 coupled to level 2 (L2) cache circuitry 876. In one example, the memory access circuitry 864 may include load unit circuitry, store address unit circuitry, and store data unit circuitry, each of which is coupled to the data TLB circuitry 872 in the memory unit circuitry 870. The instruction cache circuitry 834 is further coupled to the level 2 (L2) cache circuitry 876 in the memory unit circuitry 870. In one example, the instruction cache 834 and the data cache 874 are combined into a single instruction and data cache (not shown) in L2 cache circuitry 876, level 3 (L3) cache circuitry (not shown), and/or main memory. The L2 cache circuitry 876 is coupled to one or more other levels of cache and eventually to a main memory.

The core 890 may support one or more instructions sets (e.g., the x86 instruction set architecture (optionally with some extensions that have been added with newer versions); the MIPS instruction set architecture; the ARM instruction set architecture (optionally with optional additional extensions such as NEON)), including the instruction(s) described herein. In one example, the core 890 includes logic to support a packed data instruction set architecture extension (e.g., AVX1, AVX2), thereby allowing the operations used by many multimedia applications to be performed using packed data.

### Example Execution Unit(s) Circuitry

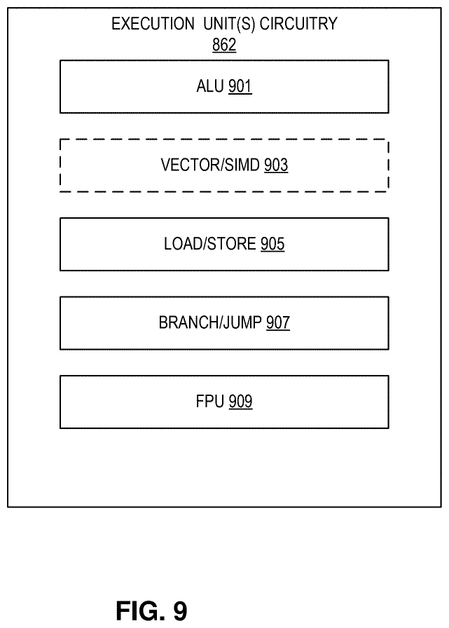

FIG. 9 illustrates examples of execution unit(s) circuitry, such as execution unit(s) circuitry 862 of FIG. 8(B). As illustrated, execution unit(s) circuitry 862 may include one or more ALU circuits 901, optional vector/single instruction multiple data (SIMD) circuits 903, load/store circuits 905, branch/jump circuits 907, and/or Floating-point unit (FPU) circuits 909. ALU circuits 901 perform integer arithmetic and/or Boolean operations. Vector/SIMD circuits 903 perform vector/SIMD operations on packed data (such as SIMD/vector registers). Load/store circuits 905 execute load and store instructions to load data from memory into registers or store from registers to memory. Load/store circuits 905 may also generate addresses. Branch/jump circuits 907 cause a branch or jump to a memory address depending on the instruction. FPU circuits 909 perform floating-point arithmetic. The width of the execution unit(s) circuitry 862 varies depending upon the example and can range from 16-bit to 1,024-bit, for example. In some examples, two or more smaller execution units are logically combined to form a larger execution unit (e.g., two 128-bit execution units are logically combined to form a 256-bit execution unit).

### Example Register Architecture

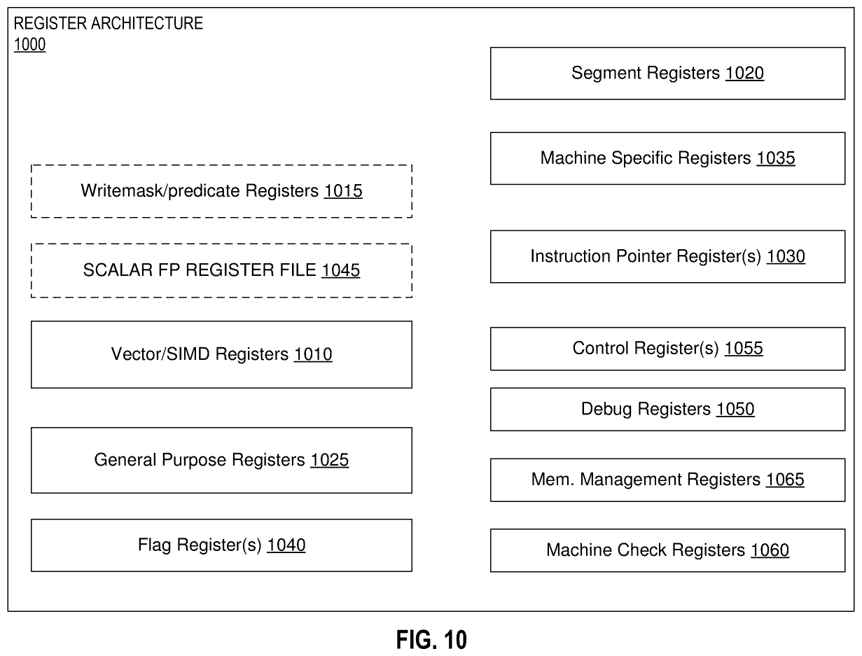

FIG. 10 is a block diagram of a register architecture 1000 according to some examples. As illustrated, the register architecture 1000 includes vector/SIMD registers 1010 that vary from 128-bit to 1,024 bits width. In some examples, the vector/SIMD registers 1010 are physically 512-bits and, depending upon the mapping, only some of the lower bits are used. For example, in some examples, the vector/SIMD registers 1010 are ZMM registers which are 512 bits: the lower 256 bits are used for YMM registers and the lower 128 bits are used for XMM registers. As such, there is an overlay of registers. In some examples, a vector length field selects between a maximum length and one or more other shorter lengths, where each such shorter length is half the length of the preceding length. Scalar operations are operations performed on the lowest order data element position in a ZMM/YMM/XMM register; the higher order data element positions are either left the same as they were prior to the instruction or zeroed depending on the example.

In some examples, the register architecture 1000 includes writemask/predicate registers 1015. For example, in some examples, there are 8 writemask/predicate registers (sometimes called k0 through k7) that are each 16-bit, 32-bit, 64-bit, or 128-bit in size. Writemask/predicate registers 1015 may allow for merging (e.g., allowing any set of elements in the destination to be protected from updates during the execution of any operation) and/or zeroing (e.g., zeroing vector masks allow any set of elements in the destination to be zeroed during the execution of any operation). In some examples, each data element position in a given writemask/predicate register 1015 corresponds to a data element position of the destination. In other examples, the writemask/predicate registers 1015 are scalable and consists of a set number of enable bits for a given vector element (e.g., 8 enable bits per 64-bit vector element).

The register architecture 1000 includes a plurality of general-purpose registers 1025. These registers may be 16-bit, 32-bit, 64-bit, etc. and can be used for scalar operations. In some examples, these registers are referenced by the names RAX, RBX, RCX, RDX, RBP, RSI, RDI, RSP, and R8 through R15.

In some examples, the register architecture 1000 includes scalar floating-point (FP) register file 1045 which is used for scalar floating-point operations on 32/64/80-bit floating-point data using the x87 instruction set architecture extension or as MMX registers to perform operations on 64-bit packed integer data, as well as to hold operands for some operations performed between the MMX and XMM registers.

One or more flag registers 1040 (e.g., EFLAGS, RFLAGS, etc.) store status and control information for arithmetic, compare, and system operations. For example, the one or more flag registers 1040 may store condition code information such as carry, parity, auxiliary carry, zero, sign, and overflow. In some examples, the one or more flag registers 1040 are called program status and control registers.

Segment registers 1020 contain segment points for use in accessing memory. In some examples, these registers are referenced by the names CS, DS, SS, ES, FS, and GS.

Machine specific registers (MSRs) 1035 control and report on processor performance. Most MSRs 1035 handle system-related functions and are not accessible to an application program. Machine check registers 1060 consist of control, status, and error reporting MSRs that are used to detect and report on hardware errors.

One or more instruction pointer register(s) 1030 store an instruction pointer value. Control register(s) 1055 (e.g., CR0-CR4) determine the operating mode of a processor (e.g., processor 670, 680, 638, 615, and/or 700) and the characteristics of a currently executing task. Debug registers 1050 control and allow for the monitoring of a processor or core's debugging operations.

Memory (mem) management registers 1065 specify the locations of data structures used in protected mode memory management. These registers may include a global descriptor table register (GDTR), interrupt descriptor table register (IDTR), task register, and a local descriptor table register (LDTR) register.

Alternative examples may use wider or narrower registers. Additionally, alternative examples may use more, less, or different register files and registers. The register architecture 1000 may, for example, be used in register file/memory 'ISAB08, or physical register file(s) circuitry 8 58.

### Instruction Set Architectures.

An instruction set architecture (ISA) may include one or more instruction formats. A given instruction format may define various fields (e.g., number of bits, location of bits) to specify, among other things, the operation to be performed (e.g., opcode) and the operand(s) on which that operation is to be performed and/or other data field(s) (e.g., mask). Some instruction formats are further broken down through the definition of instruction templates (or sub-formats). For example, the instruction templates of a given instruction format may be defined to have different subsets of the instruction format's fields (the included fields are typically in the same order, but at least some have different bit positions because there are less fields included) and/or defined to have a given field interpreted differently. Thus, each instruction of an ISA is expressed using a given instruction format (and, if defined, in a given one of the instruction templates of that instruction format) and includes fields for specifying the operation and the operands. For example, an example ADD instruction has a specific opcode and an instruction format that includes an opcode field to specify that opcode and operand fields to select operands (source1/destination and source2); and an occurrence of this ADD instruction in an instruction stream will have specific contents in the operand fields that select specific operands. In addition, though the description below is made in the context of x86 ISA, it is within the knowledge of one skilled in the art to apply the teachings of the present disclosure in another ISA.

### Example Instruction Formats

Examples of the instruction(s) described herein may be embodied in different formats. Additionally, example systems, architectures, and pipelines are detailed below. Examples of the instruction(s) may be executed on such systems, architectures, and pipelines, but are not limited to those detailed.

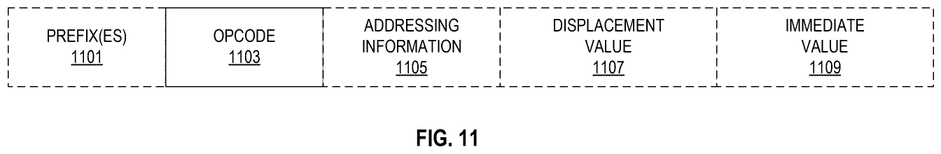

FIG. 11 illustrates examples of an instruction format. As illustrated, an instruction may include multiple components including, but not limited to, one or more fields for: one or more prefixes 1101, an opcode 1103, addressing information 1105 (e.g., register identifiers, memory addressing information, etc.), a displacement value 1107, and/or an immediate value 1109. Note that some instructions utilize some or all the fields of the format whereas others may only use the field for the opcode 1103. In some examples, the order illustrated is the order in which these fields are to be encoded, however, it should be appreciated that in other examples these fields may be encoded in a different order, combined, etc.

The prefix(es) field(s) 1101, when used, modifies an instruction. In some examples, one or more prefixes are used to repeat string instructions (e.g., 0xF0, 0xF2, 0xF3, etc.), to provide section overrides (e.g., 0x2E, 0x36, 0x3E, 0x26, 0x64, 0x65, 0x2E, 0x3E, etc.), to perform bus lock operations, and/or to change operand (e.g., 0x66) and address sizes (e.g., 0x67). Certain instructions require a mandatory prefix (e.g., 0x66, 0xF2, 0xF3, etc.). Certain of these prefixes may be considered “legacy” prefixes. Other prefixes, one or more examples of which are detailed herein, indicate, and/or provide further capability, such as specifying particular registers, etc. The other prefixes typically follow the “legacy” prefixes.

The opcode field 1103 is used to at least partially define the operation to be performed upon a decoding of the instruction. In some examples, a primary opcode encoded in the opcode field 1103 is one, two, or three bytes in length. In other examples, a primary opcode can be a different length. An additional 3-bit opcode field is sometimes encoded in another field.

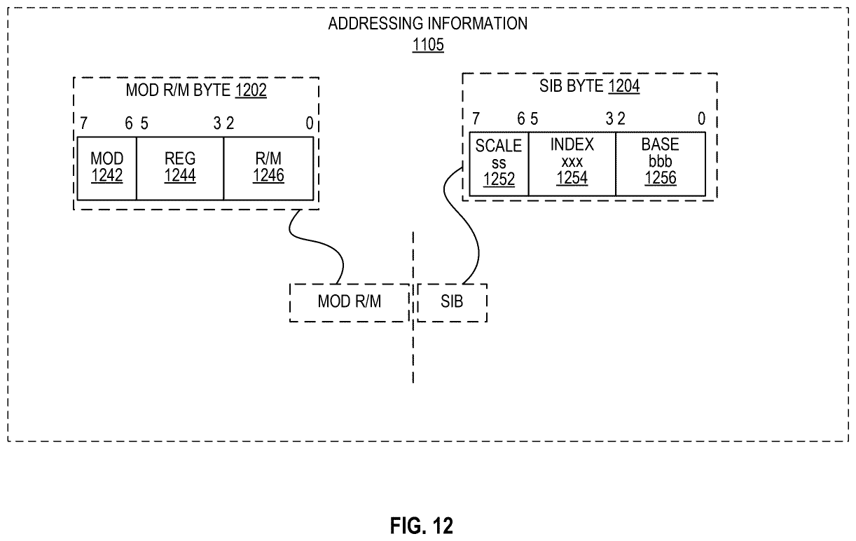

The addressing information field 1105 is used to address one or more operands of the instruction, such as a location in memory or one or more registers. FIG. 12 illustrates examples of the addressing information field 1105. In this illustration, an optional MOD R/M byte 1202 and an optional Scale, Index, Base (SIB) byte 1204 are shown. The MOD R/M byte 1202 and the SIB byte 1204 are used to encode up to two operands of an instruction, each of which is a direct register or effective memory address. Note that both fields are optional in that not all instructions include one or more of these fields. The MOD R/M byte 1202 includes a MOD field 1242, a register (reg) field 1244, and R/M field 1246.

The content of the MOD field 1242 distinguishes between memory access and non-memory access modes. In some examples, when the MOD field 1242 has a binary value of 11 (11b), a register-direct addressing mode is utilized, and otherwise a register-indirect addressing mode is used.

The register field 1244 may encode either the destination register operand or a source register operand or may encode an opcode extension and not be used to encode any instruction operand. The content of register field 1244, directly or through address generation, specifies the locations of a source or destination operand (either in a register or in memory). In some examples, the register field 1244 is supplemented with an additional bit from a prefix (e.g., prefix 1101) to allow for greater addressing.

The R/M field 1246 may be used to encode an instruction operand that references a memory address or may be used to encode either the destination register operand or a source register operand. Note the R/M field 1246 may be combined with the MOD field 1242 to dictate an addressing mode in some examples.

The SIB byte 1204 includes a scale field 1252, an index field 1254, and a base field 1256 to be used in the generation of an address. The scale field 1252 indicates a scaling factor. The index field 1254 specifies an index register to use. In some examples, the index field 1254 is supplemented with an additional bit from a prefix (e.g., prefix 1101) to allow for greater addressing. The base field 1256 specifies a base register to use. In some examples, the base field 1256 is supplemented with an additional bit from a prefix (e.g., prefix 1101) to allow for greater addressing. In practice, the content of the scale field 1252 allows for the scaling of the content of the index field 1254 for memory address generation (e.g., for address generation that uses 2^{scale}*index+base).

Some addressing forms utilize a displacement value to generate a memory address. For example, a memory address may be generated according to 2^{scale}*index+base+displacement, index*scale+displacement, r/m+displacement, instruction pointer (RIP/EIP)+displacement, register+displacement, etc. The displacement may be a 1-byte, 2-byte, 4-byte, etc. value. In some examples, the displacement field 1107 provides this value. Additionally, in some examples, a displacement factor usage is encoded in the MOD field of the addressing information field 1105 that indicates a compressed displacement scheme for which a displacement value is calculated and stored in the displacement field 1107.

In some examples, the immediate value field 1109 specifies an immediate value for the instruction. An immediate value may be encoded as a 1-byte value, a 2-byte value, a 4-byte value, etc.

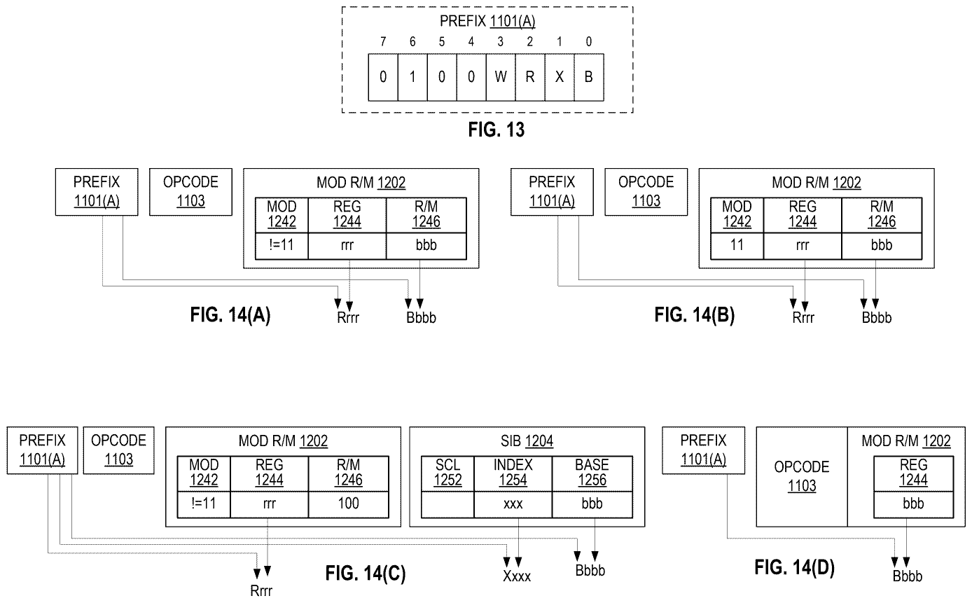

FIG. 13 illustrates examples of a first prefix 1101(A). In some examples, the first prefix 1101(A) is an example of a REX prefix. Instructions that use this prefix may specify general purpose registers, 64-bit packed data registers (e.g., single instruction, multiple data (SIMD) registers or vector registers), and/or control registers and debug registers (e.g., CR8-CR15 and DR8-DR15).

Instructions using the first prefix 1101(A) may specify up to three registers using 3-bit fields depending on the format: 1) using the reg field 1244 and the R/M field 1246 of the MOD R/M byte 1202; 2) using the MOD R/M byte 1202 with the SIB byte 1204 including using the reg field 1244 and the base field 1256 and index field 1254; or 3) using the register field of an opcode.

In the first prefix 1101(A), bit positions 7:4 are set as 0100. Bit position 3 (W) can be used to determine the operand size but may not solely determine operand width. As such, when W=0, the operand size is determined by a code segment descriptor (CS.D) and when W=1, the operand size is 64-bit.

Note that the addition of another bit allows for 16 (24) registers to be addressed, whereas the MOD R/M reg field 1244 and MOD R/M R/M field 1246 alone can each only address 8 registers.

In the first prefix 1101(A), bit position 2 (R) may be an extension of the MOD R/M reg field 1244 and may be used to modify the MOD R/M reg field 1244 when that field encodes a general-purpose register, a 64-bit packed data register (e.g., a SSE register), or a control or debug register. R is ignored when MOD R/M byte 1202 specifies other registers or defines an extended opcode.

Bit position 1 (X) may modify the SIB byte index field 1254.

Bit position 0 (B) may modify the base in the MOD R/M R/M field 1246 or the SIB byte base field 1256; or it may modify the opcode register field used for accessing general purpose registers (e.g., general purpose registers 1025).

FIGS. 14(A)-(D) illustrate examples of how the R, X, and B fields of the first prefix 1101(A) are used. FIG. 14(A) illustrates R and B from the first prefix 1101(A) being used to extend the reg field 1244 and R/M field 1246 of the MOD R/M byte 1202 when the SIB byte 12 04 is not used for memory addressing. FIG. 14(B) illustrates R and B from the first prefix 1101(A) being used to extend the reg field 1244 and R/M field 1246 of the MOD R/M byte 1202 when the SIB byte 12 04 is not used (register-register addressing). FIG. 14(C) illustrates R, X, and B from the first prefix 1101(A) being used to extend the reg field 1244 of the MOD R/M byte 1202 and the index field 1254 and base field 1256 when the SIB byte 12 04 being used for memory addressing. FIG. 14(D) illustrates B from the first prefix 1101(A) being used to extend the reg field 1244 of the MOD R/M byte 1202 when a register is encoded in the opcode 1103.

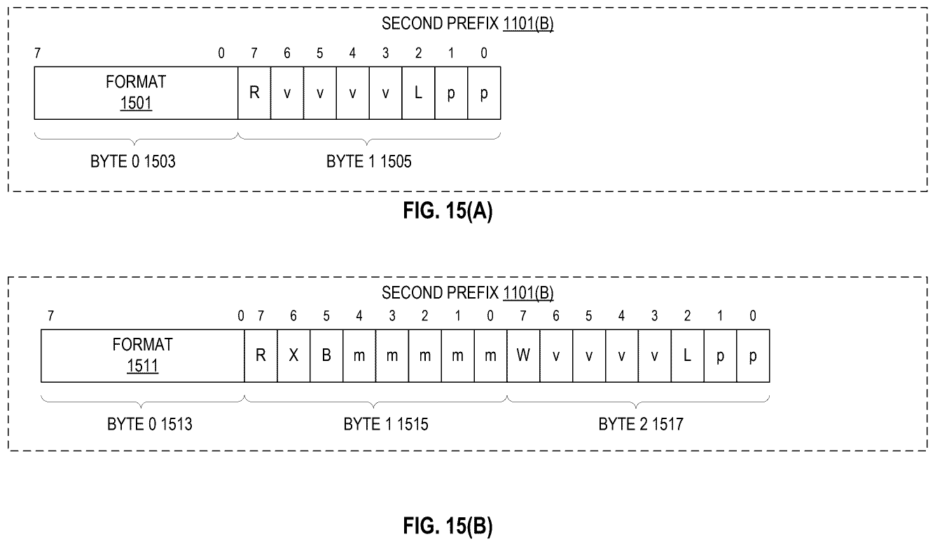

FIGS. 15(A)-(B) illustrate examples of a second prefix 1101(B). In some examples, the second prefix 1101(B) is an example of a VEX prefix. The second prefix 1101(B) encoding allows instructions to have more than two operands, and allows SIMD vector registers (e.g., vector/SIMD registers 1010) to be longer than 64-bits (e.g., 128-bit and 256-bit). The use of the second prefix 1101(B) provides for three-operand (or more) syntax. For example, previous two-operand instructions performed operations such as A=A+B, which overwrites a source operand. The use of the second prefix 1101(B) enables operands to perform nondestructive operations such as A=B+C.

In some examples, the second prefix 1101(B) comes in two forms—a two-byte form and a three-byte form. The two-byte second prefix 1101(B) is used mainly for 128-bit, scalar, and some 256-bit instructions; while the three-byte second prefix 1101(B) provides a compact replacement of the first prefix 1101(A) and 3-byte opcode instructions.

FIG. 15(A) illustrates examples of a two-byte form of the second prefix 1101(B). In one example, a format field 1501 (byte 0 1503) contains the value C5H. In one example, byte 1 1505 includes an “R” value in bit[7]. This value is the complement of the “R” value of the first prefix 1101(A). Bit[2] is used to dictate the length (L) of the vector (where a value of 0 is a scalar or 128-bit vector and a value of 1 is a 256-bit vector). Bits[1:0] provide opcode extensionality equivalent to some legacy prefixes (e.g., 00=no prefix, 01=66H, 10=F3H, and 11=F2H). Bits[6:3] shown as vvvv may be used to: 1) encode the first source register operand, specified in inverted (Is complement) form and valid for instructions with 2 or more source operands; 2) encode the destination register operand, specified in is complement form for certain vector shifts; or 3) not encode any operand, the field is reserved and should contain a certain value, such as 1111b.

Instructions that use this prefix may use the MOD R/M R/M field 1246 to encode the instruction operand that references a memory address or encode either the destination register operand or a source register operand.

Instructions that use this prefix may use the MOD R/M reg field 1244 to encode either the destination register operand or a source register operand, or to be treated as an opcode extension and not used to encode any instruction operand.

For instruction syntax that supports four operands, vvvv, the MOD R/M R/M field 1246 and the MOD R/M reg field 1244 encode three of the four operands. Bits[7:4] of the immediate value field 1109 are then used to encode the third source register operand.

FIG. 15(B) illustrates examples of a three-byte form of the second prefix 1101(B). In one example, a format field 1511 (byte 0 1513) contains the value C4H. Byte 1 1515 includes in bits[7:5]“R,” “X,” and “B” which are the complements of the same values of the first prefix 1101(A). Bits[4:0] of byte 1 1515 (shown as mmmmm) include content to encode, as needed, one or more implied leading opcode bytes. For example, 00001 implies a OFH leading opcode, 00010 implies a 0F38H leading opcode, 00011 implies a 0F3AH leading opcode, etc.

Bit[7] of byte 2 1517 is used like W of the first prefix 1101(A) including helping to determine promotable operand sizes. Bit[2] is used to dictate the length (L) of the vector (where a value of 0 is a scalar or 128-bit vector and a value of 1 is a 256-bit vector). Bits[1:0] provide opcode extensionality equivalent to some legacy prefixes (e.g., 00=no prefix, 01=66H, 10=F3H, and 11=F2H). Bits[6:3], shown as vvvv, may be used to: 1) encode the first source register operand, specified in inverted (is complement) form and valid for instructions with 2 or more source operands; 2) encode the destination register operand, specified in is complement form for certain vector shifts; or 3) not encode any operand, the field is reserved and should contain a certain value, such as 1111b.

Instructions that use this prefix may use the MOD R/M R/M field 1246 to encode the instruction operand that references a memory address or encode either the destination register operand or a source register operand.

Instructions that use this prefix may use the MOD R/M reg field 1244 to encode either the destination register operand or a source register operand, or to be treated as an opcode extension and not used to encode any instruction operand.

For instruction syntax that supports four operands, vvvv, the MOD R/M R/M field 1246, and the MOD R/M reg field 1244 encode three of the four operands. Bits[7:4] of the immediate value field 1109 are then used to encode the third source register operand.

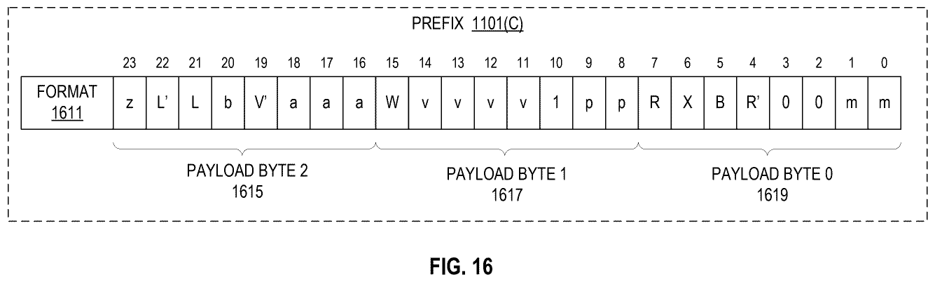

FIG. 16 illustrates examples of a third prefix 1101(C). In some examples, the third prefix 1101(C) is an example of an EVEX prefix. The third prefix 1101(C) is a four-byte prefix.

The third prefix 1101(C) can encode 32 vector registers (e.g., 128-bit, 256-bit, and 512-bit registers) in 64-bit mode. In some examples, instructions that utilize a writemask/opmask (see discussion of registers in a previous figure, such as FIG. 10) or predication utilize this prefix. Opmask register allows for conditional processing or selection control. Opmask instructions, whose source/destination operands are opmask registers and treat the content of an opmask register as a single value, are encoded using the second prefix 1101(B).

The third prefix 1101(C) may encode functionality that is specific to instruction classes (e.g., a packed instruction with “load+op” semantic can support embedded broadcast functionality, a floating-point instruction with rounding semantic can support static rounding functionality, a floating-point instruction with non-rounding arithmetic semantic can support “suppress all exceptions” functionality, etc.).

The first byte of the third prefix 1101(C) is a format field 1611 that has a value, in one example, of 62H. Subsequent bytes are referred to as payload bytes 1615-1619 and collectively form a 24-bit value of P[23:0] providing specific capability in the form of one or more fields (detailed herein).

In some examples, P[1:0] of payload byte 1619 are identical to the low two mm bits. P[3:2] are reserved in some examples. Bit P[4](R′) allows access to the high 16 vector register set when combined with P[7] and the MOD R/M reg field 1244. P[6] can also provide access to a high 16 vector register when SIB-type addressing is not needed. P[7:5] consist of R, X, and B which are operand specifier modifier bits for vector register, general purpose register, memory addressing and allow access to the next set of 8 registers beyond the low 8 registers when combined with the MOD R/M register field 1244 and MOD R/M R/M field 1246. P[9:8] provides opcode extensionality equivalent to some legacy prefixes (e.g., 00=no prefix, 01=66H, 10=F3H, and 11=F2H). P[10] in some examples is a fixed value of 1. P[14:11], shown as vvvv, may be used to: 1) encode the first source register operand, specified in inverted (Is complement) form and valid for instructions with 2 or more source operands; 2) encode the destination register operand, specified in is complement form for certain vector shifts; or 3) not encode any operand, the field is reserved and should contain a certain value, such as 1111b.

P[15] is like W of the first prefix 1101(A) and second prefix 1111(B) and may serve as an opcode extension bit or operand size promotion.

P[18:16] specify the index of a register in the opmask (writemask) registers (e.g., writemask/predicate registers 1015). In one example, the specific value aaa=000 has a special behavior implying no opmask is used for the particular instruction (this may be implemented in a variety of ways including the use of an opmask hardwired to all ones or hardware that bypasses the masking hardware). When merging, vector masks allow any set of elements in the destination to be protected from updates during the execution of any operation (specified by the base operation and the augmentation operation); in other one example, preserving the old value of each element of the destination where the corresponding mask bit has a 0. In contrast, when zeroing vector masks allow any set of elements in the destination to be zeroed during the execution of any operation (specified by the base operation and the augmentation operation); in one example, an element of the destination is set to 0 when the corresponding mask bit has a 0 value. A subset of this functionality is the ability to control the vector length of the operation being performed (that is, the span of elements being modified, from the first to the last one); however, it is not necessary that the elements that are modified be consecutive. Thus, the opmask field allows for partial vector operations, including loads, stores, arithmetic, logical, etc. While examples are described in which the opmask field's content selects one of a number of opmask registers that contains the opmask to be used (and thus the opmask field's content indirectly identifies that masking to be performed), alternative examples instead or additional allow the mask write field's content to directly specify the masking to be performed.

P[19] can be combined with P[14:11] to encode a second source vector register in a non-destructive source syntax which can access an upper 16 vector registers using P[19]. P[20] encodes multiple functionalities, which differ across different classes of instructions and can affect the meaning of the vector length/rounding control specifier field (P[22:21]). P[23] indicates support for merging-writemasking (e.g., when set to 0) or support for zeroing and merging-writemasking (e.g., when set to 1).

Example examples of encoding of registers in instructions using the third prefix 1101(C) are detailed in the following tables.

TABLE 1
32-Register Support in 64-bit Mode

| | 4 | 3 | [2:0] | REG. TYPE | COMMON USAGES |
|---|---|---|---|---|---|
| REG | R′ | R | MOD R/M | GPR, Vector | Destination or Source |
| | | | reg | GPR, Vector | |
| VVVV | V′ | vvvv | | GPR, Vector | 2nd Source or |
| | | | | | Destination |
| RM | X | B | MOD R/M | GPR, Vector | 1st Source or |
| | | | R/M | | Destination |
| BASE | 0 | B | MOD R/M | GPR | Memory addressing |
| | | | R/M | | |
| INDEX | 0 | X | SIB.index | GPR | Memory addressing |
| VIDX | V′ | X | SIB.index | Vector | VSIB memory |
| | | | | | addressing |

TABLE 2
Encoding Register Specifiers in 32-bit Mode

| | [2:0] | REG. TYPE | COMMON USAGES |
|---|---|---|---|
| REG | MOD R/M reg | GPR, Vector | Destination or Source |
| VVVV | vvvv | GPR, Vector | 2^{nd} Source or Destination |
| RM | MOD R/M R/M | GPR, Vector | 1^{st} Source or Destination |
| BASE | MOD R/M R/M | GPR | Memory addressing |
| INDEX | SIB.index | GPR | Memory addressing |
| VIDX | SIB.index | Vector | VSIB memory addressing |

TABLE 3
Opmask Register Specifier Encoding

| | [2:0] | REG. TYPE | COMMON USAGES |
|---|---|---|---|
| REG | MOD R/M Reg | k0-k7 | Source |
| VVVV | vvvv | k0-k7 | 2^{nd} Source |
| RM | MOD R/M R/M | k0-k7 | 1^{st} Source |
| {k1} | aaa | k0-k7 | Opmask |

Program code may be applied to input information to perform the functions described herein and generate output information. The output information may be applied to one or more output devices, in known fashion. For purposes of this application, a processing system includes any system that has a processor, such as, for example, a digital signal processor (DSP), a microcontroller, an application specific integrated circuit (ASIC), a field programmable gate array (FPGA), a microprocessor, or any combination thereof.

The program code may be implemented in a high-level procedural or object-oriented programming language to communicate with a processing system. The program code may also be implemented in assembly or machine language, if desired. In fact, the mechanisms described herein are not limited in scope to any particular programming language. In any case, the language may be a compiled or interpreted language.

Examples of the mechanisms disclosed herein may be implemented in hardware, software, firmware, or a combination of such implementation approaches. Examples may be implemented as computer programs or program code executing on programmable systems comprising at least one processor, a storage system (including volatile and non-volatile memory and/or storage elements), at least one input device, and at least one output device.

One or more aspects of at least one example may be implemented by representative instructions stored on a machine-readable medium which represents various logic within the processor, which when read by a machine causes the machine to fabricate logic to perform the techniques described herein. Such representations, known as “intellectual property (IP) cores” may be stored on a tangible, machine readable medium and supplied to various customers or manufacturing facilities to load into the fabrication machines that make the logic or processor.

Such machine-readable storage media may include, without limitation, non-transitory, tangible arrangements of articles manufactured or formed by a machine or device, including storage media such as hard disks, any other type of disk including floppy disks, optical disks, compact disk read-only memories (CD-ROMs), compact disk rewritables (CD-RWs), and magneto-optical disks, semiconductor devices such as read-only memories (ROMs), random access memories (RAMs) such as dynamic random access memories (DRAMs), static random access memories (SRAMs), erasable programmable read-only memories (EPROMs), flash memories, electrically erasable programmable read-only memories (EEPROMs), phase change memory (PCM), magnetic or optical cards, or any other type of media suitable for storing electronic instructions.

Accordingly, examples also include non-transitory, tangible machine-readable media containing instructions or containing design data, such as Hardware Description Language (HDL), which defines structures, circuits, apparatuses, processors, and/or system features described herein. Such examples may also be referred to as program products.

### Emulation (Including Binary Translation, Code Morphing, Etc.).

In some cases, an instruction converter may be used to convert an instruction from a source instruction set architecture to a target instruction set architecture. For example, the instruction converter may translate (e.g., using static binary translation, dynamic binary translation including dynamic compilation), morph, emulate, or otherwise convert an instruction to one or more other instructions to be processed by the core. The instruction converter may be implemented in software, hardware, firmware, or a combination thereof. The instruction converter may be on processor, off processor, or part on and part off processor.

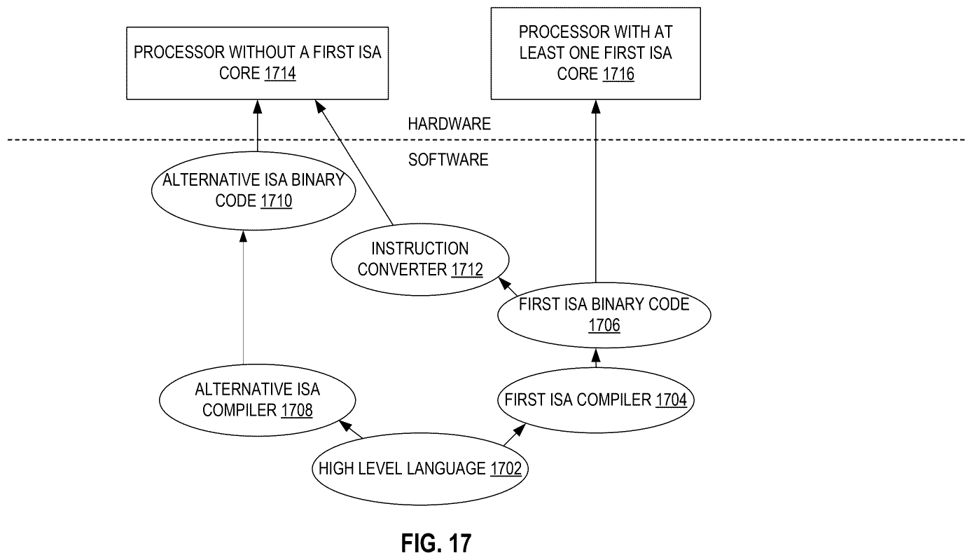

FIG. 17 is a block diagram illustrating the use of a software instruction converter to convert binary instructions in a source ISA to binary instructions in a target ISA according to examples. In the illustrated example, the instruction converter is a software instruction converter, although alternatively the instruction converter may be implemented in software, firmware, hardware, or various combinations thereof. FIG. 17 shows a program in a high-level language 1702 may be compiled using a first ISA compiler 1704 to generate first ISA binary code 1706 that may be natively executed by a processor with at least one first ISA core 1716. The processor with at least one first ISA core 1716 represents any processor that can perform substantially the same functions as an Intel® processor with at least one first ISA core by compatibly executing or otherwise processing (1) a substantial portion of the first ISA or (2) object code versions of applications or other software targeted to run on an Intel processor with at least one first ISA core, in order to achieve substantially the same result as a processor with at least one first ISA core. The first ISA compiler 1704 represents a compiler that is operable to generate the first ISA binary code 1706 (e.g., object code) that can, with or without additional linkage processing, be executed on the processor with at least one first ISA core 1716. Similarly, FIG. 17 shows the program in the high-level language 1702 may be compiled using an alternative ISA compiler 1708 to generate alternative ISA binary code 1710 that may be natively executed by a processor without a first ISA core 1714. The instruction converter 1712 is used to convert the first ISA binary code 1706 into code that may be natively executed by the processor without a first ISA core 1714. This converted code is not necessarily to be the same as the alternative ISA binary code 1710; however, the converted code will accomplish the general operation and be made up of instructions from the alternative ISA. Thus, the instruction converter 1712 represents software, firmware, hardware, or a combination thereof that, through emulation, simulation, or any other process, allows a processor or other electronic device that does not have a first ISA processor or core to execute the first ISA binary code 1706.

Components, features, and details described for any of FIGS. 2 and 4 may also optionally apply to any of FIGS. 3 and 5. Components, features, and details described for any of the apparatus disclosed herein (e.g., processor 538) may optionally apply to any of the methods disclosed herein (e.g., method 210), which in embodiments may optionally be performed by and/or with such processors. Any of the apparatus described herein (e.g., processor 538) in embodiments may optionally be included in any of the systems disclosed herein (e.g., any of the systems of FIGS. 6-7). Any of the apparatus or processors disclosed herein (e.g., processor 538) may optionally have any of the microarchitectures shown herein (e.g., any shown in FIGS. 8-10).

References to “one example,” “an example,” etc., indicate that the example described may include a particular feature, structure, or characteristic, but every example may not necessarily include the particular feature, structure, or characteristic. Moreover, such phrases do not necessarily refer to the same example. Further, when a particular feature, structure, or characteristic is described in connection with an example, it is submitted that it is within the knowledge of one skilled in the art to affect such feature, structure, or characteristic in connection with other examples whether explicitly described.

Processor components disclosed herein may be said and/or claimed to be operative, operable, capable, able, configured adapted, or otherwise to perform an operation. For example, a decoder may be said and/or claimed to decode an instruction, an execution unit may be said and/or claimed to store a result, or the like. As used herein, these expressions refer to the characteristics, properties, or attributes of the components when in a powered-off state, and do not imply that the components or the device or apparatus in which they are included is currently powered on or operating. For clarity, it is to be understood that the processors and apparatus claimed herein are not claimed as being powered on or running.

In the description and claims, the terms “coupled” and/or “connected,” along with their derivatives, may have been used. These terms are not intended as synonyms for each other. Rather, in embodiments, “connected” may be used to indicate that two or more elements are in direct physical and/or electrical contact with each other. “Coupled” may mean that two or more elements are in direct physical and/or electrical contact with each other. However, “coupled” may also mean that two or more elements are not in direct contact with each other, yet still co-operate or interact with each other. For example, an execution unit may be coupled with a register and/or a decode unit through one or more intervening components. In the figures, arrows are used to show connections and couplings.

Some embodiments include an article of manufacture (e.g., a computer program product) that includes a machine-readable medium. The medium may include a mechanism that provides, for example stores, information in a form that is readable by the machine. The machine-readable medium may provide, or have stored thereon, an instruction or sequence of instructions, that if and/or when executed by a machine are operative to cause the machine to perform and/or result in the machine performing one or operations, methods, or techniques disclosed herein.

In some embodiments, the machine-readable medium may include a tangible and/or non-transitory machine-readable storage medium. For example, the non-transitory machine-readable storage medium may include a floppy diskette, an optical storage medium, an optical disk, an optical data storage device, a CD-ROM, a magnetic disk, a magneto-optical disk, a read only memory (ROM), a programmable ROM (PROM), an erasable-and-programmable ROM (EPROM), an electrically-erasable-and-programmable ROM (EEPROM), a random access memory (RAM), a static-RAM (SRAM), a dynamic-RAM (DRAM), a Flash memory, a phase-change memory, a phase-change data storage material, a non-volatile memory, a non-volatile data storage device, a non-transitory memory, a non-transitory data storage device, or the like. The non-transitory machine-readable storage medium does not consist of a transitory propagated signal. In some embodiments, the storage medium may include a tangible medium that includes solid-state matter or material, such as, for example, a semiconductor material, a phase change material, a magnetic solid material, a solid data storage material, etc. Alternatively, a non-tangible transitory computer-readable transmission media, such as, for example, an electrical, optical, acoustical, or other form of propagated signals—such as carrier waves, infrared signals, and digital signals, may optionally be used.

Examples of suitable machines include, but are not limited to, a general-purpose processor, a special-purpose processor, a digital logic circuit, an integrated circuit, or the like. Still other examples of suitable machines include a computer system or other electronic device that includes a processor, a digital logic circuit, or an integrated circuit. Examples of such computer systems or electronic devices include, but are not limited to, desktop computers, laptop computers, notebook computers, tablet computers, netbooks, smartphones, cellular phones, servers, network devices (e.g., routers and switches.), Mobile Internet devices (MIDs), media players, smart televisions, nettops, set-top boxes, and video game controllers.

Moreover, in the various examples described above, unless specifically noted otherwise, disjunctive language such as the phrase “at least one of A, B, or C” or “A, B, and/or C” is intended to be understood to mean either A, B, or C, or any combination thereof (i.e. A and B, A and C, B and C, and A, B and C).

In the description above, specific details have been set forth to provide a thorough understanding of the embodiments. However, other embodiments may be practiced without some of these specific details. Various modifications and changes may be made thereunto without departing from the broader spirit and scope of the disclosure as set forth in the claims. The specification and drawings are, accordingly, to be regarded in an illustrative rather than a restrictive sense. The scope of the invention is not to be determined by the specific examples provided above, but only by the claims below. In other instances, well-known circuits, structures, devices, and operations have been shown in block diagram form and/or without detail to avoid obscuring the understanding of the description.

### EXAMPLE EMBODIMENTS

The following examples pertain to further embodiments. Specifics in the examples may be used anywhere in one or more embodiments.
Example 1 is a processor including a decode unit to decode a first instruction, to decode a second instruction after the first instruction, and to decode a third instruction after the second instruction. The first instruction is to specify a source register, a first immediate, and a destination register. The second instruction is to specify the destination register of the first instruction as a source register, a second immediate, and a destination register. The third instruction is to specify the destination register of the second instruction as a source register. The processor also includes circuitry, based on the third instruction, when an operand size of the second instruction is wider than an operand size of the first instruction, to generate a second value from a first value obtained from a physical register that the destination register of the second instruction is mapped to via register renaming. This may include to truncate bits of the first value more significant than the operand size of the first instruction. Then, this may include generating a value of the destination register of the second instruction, including to combine the second value with an accumulated immediate incorporating at least the first immediate and the second immediate.
Example 2 includes the processor of Example 1, where the destination registers of the first and second instructions are a general-purpose register.
Example 3 includes the processor of any one of Examples 1 to 2, where the first operand size is 32 bits.
Example 4 includes the processor of any one of Examples 1 to 3, where the second operand size is 64 bits.
Example 5 includes the processor of any one of Examples 1 to 4, where the destination registers of the first and second instructions are a general-purpose register, optionally where the first operand size is 32 bits, and optionally where the second operand size is 64 bits.
Example 6 includes the processor of any one of Examples 1 to 5, further including, circuitry, based on the third instruction, when the operand size of the second instruction is narrower than the operand size of the first instruction, to generate a combined value, including to combine the first value, obtained from the physical register that the destination register of the second instruction is mapped to via register renaming, with the accumulated immediate incorporating at least the first immediate and the second immediate. Then, the value of the destination register of the second instruction may be generated, including to truncate bits of the combined value more significant than the operand size of the second instruction.
Example 7 includes the processor of any one of Examples 1 to 6, where the circuitry is to access a first value from a first field of an entry of a register alias table corresponding to the destination register of the second instruction, the first value from the first field to indicate that the truncation of the bits of the first value are to be performed before the combination with the accumulated immediate.
Example 8 includes the method of Example 7, where the circuitry is to access a second value from a second field of the entry of the register alias table, the second value from the second field to indicate whether the truncation is to be performed using zero extension or sign extension.
Example 9 includes the processor of any one of Examples 1 to 8, where the first instruction has a first opcode to indicate that the first immediate is to be combined with the source register of the first instruction, and optionally where the second instruction has a second opcode to indicate that the second immediate is to be combined with the source register of the second instruction.
Example 10 includes the processor of any one of Examples 1 to 9, further including an execution unit to perform one or more operations corresponding to the third instruction on the value of the destination register of the second instruction.
Example 11 is a method including decoding a first instruction, decoding a second instruction after the first instruction, and decoding a third instruction after the second instruction. The first instruction specifies a source register, a first immediate, and a destination register. The second instruction specifies the destination register of the first instruction as a source register, a second immediate, and a destination register. The third instruction specifies the destination register of the second instruction as a source register. When an operand size of the second instruction is wider than an operand size of the first instruction, the method may include performing operations associated with the third instruction, including generating a second value from a first value obtained from a physical register that the destination register of the second instruction is mapped to via register renaming. This may include truncating bits of the first value more significant than the operand size of the first instruction. Then, the method may include generating a value of the destination register of the second instruction, including combining the second value with an accumulated immediate incorporating at least the first immediate and the second immediate.
Example 12 includes the method of Example 11, where the destination registers of the first and second registers are a general-purpose register.
Example 13 includes the method of any one of Examples 11 to 12, where the first operand size is 32 bits, and where the second operand size is 64 bits.
Example 14 includes the method of any one of Examples 11 to 13, where the destination registers of the first and second registers are a general-purpose register, optionally where the first operand size is 32 bits, and optionally where the second operand size is 64 bits.
Example 15 includes the method of any one of Examples 11 to 14, further including accessing a first value from a first field of an entry of a register alias table corresponding to the destination register of the second instruction, the first value from the first field indicating that the truncation of the bits of the first value are to be performed before the combination with the accumulated immediate.
Example 16 includes the method of any one of Examples 11 to 15, further including accessing a second value from a second field of the entry of the register alias table, the second value from the second field indicating whether the truncation is to be performed using zero extension or sign extension.
Example 17 includes the method of any one of Examples 11 to 16, where the first instruction has a first opcode indicating that the first immediate is to be combined with the source register of the first instruction, and optionally where the second instruction has a second opcode indicating that the second immediate is to be combined with the source register of the second instruction.
Example 18 is a processor or other apparatus operative to perform the method of any one of Examples 11 to 17.
Example 19 is a processor or other apparatus that includes means for performing the method of any one of Examples 11 to 17.
Example 20 is a processor or other apparatus that includes any combination of modules and/or units and/or logic and/or circuitry and/or means operative to perform the method of any one of Examples 11 to 17.

What is claimed is:

1. A processor comprising:
a decode unit to decode a first instruction, to decode a second instruction after the first instruction, and to decode a third instruction after the second instruction, the first instruction to specify a source register, a first immediate, and a destination register, the second instruction to specify the destination register of the first instruction as a source register, a second immediate, and a destination register, the third instruction to specify the destination register of the second instruction as a source register; and
circuitry, based on the third instruction, when an operand size of the second instruction is wider than an operand size of the first instruction, to:
generate a second value from a first value obtained from a physical register that the destination register of the second instruction is mapped to via register renaming, including to truncate bits of the first value more significant than the operand size of the first instruction; and
generate a value of the destination register of the second instruction, including to combine the second value with an accumulated immediate incorporating at least the first immediate and the second immediate.

2. The processor of claim 1, wherein the destination registers of the first and second instructions are a general-purpose register.

3. The processor of claim 1, wherein the first operand size is 32 bits.

4. The processor of claim 3, wherein the second operand size is 64 bits.

5. The processor of claim 1, wherein the destination registers of the first and second instructions are a general-purpose register, wherein the first operand size is 32 bits, and wherein the second operand size is 64 bits.

6. The processor of claim 1, further comprising, circuitry, based on the third instruction, when the operand size of the second instruction is narrower than the operand size of the first instruction, to:
generate a combined value, including to combine the first value, obtained from the physical register that the destination register of the second instruction is mapped to via register renaming, with the accumulated immediate incorporating at least the first immediate and the second immediate; and
generate the value of the destination register of the second instruction, including to truncate bits of the combined value more significant than the operand size of the second instruction.

7. The processor of claim 1, wherein the circuitry is to access a first value from a first field of an entry of a register alias table corresponding to the destination register of the second instruction, the first value from the first field to indicate that the truncation of the bits of the first value are to be performed before the combination with the accumulated immediate.

8. The method of claim 7, wherein the circuitry is to access a second value from a second field of the entry of the register alias table, the second value from the second field to indicate whether the truncation is to be performed using zero extension or sign extension.

9. The processor of claim 1, wherein the first instruction has a first opcode to indicate that the first immediate is to be combined with the source register of the first instruction, and wherein the second instruction has a second opcode to indicate that the second immediate is to be combined with the source register of the second instruction.

10. The processor of claim 1, further comprising an execution unit to perform one or more operations corresponding to the third instruction on the value of the destination register of the second instruction.

11. A method comprising:
decoding a first instruction, decoding a second instruction after the first instruction, and decoding a third instruction after the second instruction, the first instruction specifying a source register, a first immediate, and a destination register, the second instruction specifying the destination register of the first instruction as a source register, a second immediate, and a destination register, the third instruction specifying the destination register of the second instruction as a source register; and
when an operand size of the second instruction is wider than an operand size of the first instruction, performing operations associated with the third instruction, including:
generating a second value from a first value obtained from a physical register that the destination register of the second instruction is mapped to via register renaming, including truncating bits of the first value more significant than the operand size of the first instruction; and
generating a value of the destination register of the second instruction, including combining the second value with an accumulated immediate incorporating at least the first immediate and the second immediate.

12. The method of claim 11, wherein the destination registers of the first and second registers are a general-purpose register.

13. The method of claim 11, wherein the first operand size is 32 bits, and wherein the second operand size is 64 bits.

14. The method of claim 11, wherein the destination registers of the first and second registers are a general-purpose register, wherein the first operand size is 32 bits, and wherein the second operand size is 64 bits.

15. The method of claim 11, further comprising accessing a first value from a first field of an entry of a register alias table corresponding to the destination register of the second instruction, the first value from the first field indicating that the truncation of the bits of the first value are to be performed before the combination with the accumulated immediate.

16. The method of claim 15, further comprising accessing a second value from a second field of the entry of the register alias table, the second value from the second field indicating whether the truncation is to be performed using zero extension or sign extension.

17. The method of claim 11, wherein the first instruction has a first opcode indicating that the first immediate is to be combined with the source register of the first instruction, and wherein the second instruction has a second opcode indicating that the second immediate is to be combined with the source register of the second instruction.

18. A system comprising:
a dynamic random access memory (DRAM); and
a processor coupled with the DRAM, the processor to:
decode a first instruction, a second instruction after the first instruction, and a third instruction after the second instruction, the first instruction to specify a source register, a first immediate, and a destination register, the second instruction to specify the destination register of the first instruction as a source register, a second immediate, and a destination register, the third instruction to specify the destination register of the second instruction as a source register; and
perform operations associated with the third instruction, including, when an operand size of the second instruction is wider than an operand size of the first instruction, to:
generate a second value from a first value obtained from a physical register that the destination register of the second instruction is mapped to via register renaming, including to truncate bits of the first value more significant than the operand size of the first instruction; and
generate a value of the destination register of the second instruction, including to combine the second value with an accumulated immediate incorporating at least the first immediate and the second immediate.

19. The system of claim 18, wherein the destination registers of the first and second instructions are a general-purpose register.

20. The system of claim 19, wherein the second operand size is 64 bits, and wherein the first operand size is one of 8 bits, 16 bits, and 32 bits.
